(19) United States
(12) Patent Application Publication
(10) Pub. No.: US 2026/0093710 A1
(43) Pub. Date: Apr. 2, 2026

(54) Multi-Turn Collaboration For Machine-Learned Inference

(71) Applicant: DeepMind Technologies Limited, London (GB)

(72) Inventors: Zi Wang, Cambridge, MA (US); Richard Galt, London (GB); Wenjun Zeng, Bellevue, WA (US); Kartikeya Badola, London (GB); Nithish Kannen, Bangalore (IN); Meera Satya Hahn, Atlanta, GA (US); Been Kim, Seattle, WA (US)

(21) Appl. No.: 19/348,187

(22) Filed: Oct. 2, 2025

(30) Foreign Application Priority Data
Oct. 2, 2024 (IN) IN202411074509

(51) Int. Cl. G06F 16/26; G06F 16/23

(52) U.S. Cl. CPC G06F 16/26; G06F 16/23

(57) ABSTRACT

Systems and methods for multi-turn collaboration for machine-learned inference are provided. A method can include receiving, by a computing system comprising one or more computing devices, a first input. The method can include generating, by the computing system based on the first input, structured data indicative of one or more target output properties for a machine-learned inference operation. The method can include receiving, by the computing system, one or more second inputs indicative of one or more changes to the one or more target output properties. The method can include updating, by the computing system, the structured data indicative of the one or more target output properties based on the second input to generate updated structured data. The method can include generating, by the computing system using a machine-learned model and based at least in part on the updated structured data, an output.

### CROSS-REFERENCE TO RELATED APPLICATIONS

The present application is based upon and claims the right of priority to India Provisional Patent Application No. 202411074509, filed on Oct. 2, 2024, the disclosure of which (including any appendices) is hereby incorporated by reference herein in its entirety for all purposes.

### FIELD

The present disclosure relates generally to machine learning processes and machine-learned devices and systems. More particularly, the present disclosure relates to systems and methods for multi-turn collaboration for machine-learned inference operations.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include receiving, by a computing system comprising one or more computing devices, a first input descriptive of requested content to be generated via a machine-learned inference operation of a generative machine-learned model. The example method can include generating, by the computing system based on the first input, structured data indicative of one or more target output properties for the machine-learned inference operation of the generative machine-learned model, the one or more target output properties being unspecified by the first input. The example method can include presenting, by the computing system, the structured data to a user via a graphical user interface comprising one or more components configured to enable the user to modify the structured data. The example method can include receiving, by the computing system via the graphical user interface, one or more second inputs indicative of one or more changes to the one or more target output properties. The example method can include updating, by the computing system, the structured data indicative of the one or more target output properties based on the second input to generate updated structured data. The example method can include generating, by the computing system using the generative machine-learned model and based at least in part on the updated structured data, an output.

In the example method, the structured data can include a probability distribution over a plurality of sets of target output properties.

In the example method, at least one second input of the one or more second inputs can be indicative of a value for a first target output property of the one or more target output properties. In the example method, updating the one or more target output properties can include updating, by the computing system, the first target output property according to the value. In the example method, updating the one or more target output properties can include updating, by the computing system based at least in part on the value, one or more probabilities associated with a second target output property of the one or more target output properties.

In the example method, the generative machine-learned model can be a first machine-learned model. In the example method, updating the one or more target output properties can include providing, by the computing system to a second machine-learned model, a third input comprising data indicative of the value and all or part of the first input. In the example method, updating the one or more target output properties can include generating, by the computing system using the second machine-learned model, one or more updated probabilities associated with the second target output property.

The example method can include generating, by the computing system based at least in part on one or more probabilities associated with the probability distribution, a graphical user interface (GUI) view. The example method can include providing, by the computing system via the graphical user interface, the GUI view to a user.

In the example method, the one or more probabilities can include one or more confidence levels. In the example method, generating the GUI view based at least in part on the one or more probabilities can include determining, by the computing system based on the one or more confidence levels, one or more entropy values associated with the one or more target output properties. In the example method, generating the GUI view based at least in part on the one or more probabilities can include selecting, by the computing system based at least in part on the one or more entropy values, according to a Markov decision process, a GUI view generation action. In the example method, generating the GUI view based at least in part on the one or more probabilities can include performing, by the computing system, the GUI view generation action.

In the example method, the structured data can include one or more importance values associated with the one or more target output properties. In the example method, selecting the GUI view generation action can be based at least in part on the one or more importance values.

In the example method, the updated structured data can include a probability distribution over a plurality of sets of target output properties. In the example method, generating the output can include sampling, by the computing system based on the probability distribution, a value for a first target output property. In the example method, generating the output can include providing, by the computing system to the generative machine-learned model, input context indicative of the value for the first target output property.

In the example method, the structured data can include graph-structured data comprising two or more entities to be included in a target output of the machine-learned inference operation and one or more relationships between the two or more entities.

In the example method, the structured data can further include one or more attributes associated with at least one entity of the two or more entities.

In the example method, the structured data can further include an importance associated with at least one entity of the two or more entities.

In the example method, the graphical user interface can include a graph-structured view of two or more entities to be included in an output of the machine-learned inference operation and one or more relationships between the two or more entities.

In the example method, the graphical user interface comprises a user prompt a prompt to select a value for a first target output property of the one or more target output properties. In the example method, receiving the second input can include receiving, by the computing system via the graphical user interface, a selection input associated with the prompt.

In the example method, the generative machine-learned model can be a first machine-learned model. In the example method, generating the structured data can include providing, by the computing system to a second machine-learned model, a third input comprising all or part of the first input. In the example method, generating the structured data can include generating, by the computing system using the second machine-learned model, the structured data.

In the example method, the third input can include a plurality of example input-output pairs. In the example method, each example input-output pair can include an example input associated with an example machine-learned inference operation and an example output comprising example structured data indicative of one or more example target output properties for the example machine-learned inference operation.

In the example method, the one or more example target output properties can include two or more example entities to be included in the example machine-learned inference operation. In the example method, the one or more example target output properties can include one or more example relationships between the two or more example entities.

In the example method, the second machine-learned model can include a language model.

In the example method, the generative machine-learned model can include an image processing model.

Example aspects of the present disclosure provide one or more example non-transitory computer-readable media storing instructions that are executable by one or more processors to cause a computing system to perform example operations. In some implementations, the example operations can include receiving a first input descriptive of requested content to be generated via a machine-learned inference operation of a generative machine-learned model. The example operations can include generating, based on the first input, structured data indicative of one or more target output properties for the machine-learned inference operation of the generative machine-learned model, the one or more target output properties being unspecified by the first input. The example operations can include presenting the structured data to a user via a graphical user interface comprising one or more components configured to enable the user to modify the structured data. The example operations can include receiving, via the graphical user interface, one or more second inputs indicative of one or more changes to the one or more target output properties. The example operations can include updating the structured data indicative of the one or more target output properties based on the second input to generate updated structured data. The example operations can include generating, using the generative machine-learned model and based at least in part on the updated structured data, an output.

Example aspects of the present disclosure provide an example computing system that includes one or more processors and one or more example non-transitory computer-readable media storing instructions that are executable by one or more processors to cause a computing system to perform example operations. In some implementations, the example operations can include receiving a first input descriptive of requested content to be generated via a machine-learned inference operation of a generative machine-learned model. The example operations can include generating, based on the first input, structured data indicative of one or more target output properties for the machine-learned inference operation of the generative machine-learned model, the one or more target output properties being unspecified by the first input. The example operations can include presenting the structured data to a user via a graphical user interface comprising one or more components configured to enable the user to modify the structured data. The example operations can include receiving, via the graphical user interface, one or more second inputs indicative of one or more changes to the one or more target output properties. The example operations can include updating the structured data indicative of the one or more target output properties based on the second input to generate updated structured data. The example operations can include generating, using the generative machine-learned model and based at least in part on the updated structured data, an output.

In the example computing system, the graphical user interface can include one or more clarification questions associated with the one or more output properties that are unspecified by the first input. In the example computing system, the graphical user interface can include a question-answering input component for answering the one or more clarification questions.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example system for machine-learned inference based on a collaboratively updated belief state according to some aspects of the present disclosure.

FIG. 2 is a block diagram of an example system for machine-learned inference based on a collaboratively updated belief state according to some aspects of the present disclosure.

FIG. 3 is a block diagram of an example system for machine-learned inference based on a collaboratively updated belief state according to some aspects of the present disclosure.

FIG. 4 is a block diagram of an example system for machine-learned inference based on a collaboratively updated belief state according to some aspects of the present disclosure.

FIG. 5 is a block diagram of an example Markov decision process according to some aspects of the present disclosure.

FIG. 6 is an illustration of an example graphical user interface (GUI) view for collaboratively updating a belief state according to some aspects of the present disclosure.

FIG. 7 is an illustration of an example GUI view for collaboratively updating a belief state according to some aspects of the present disclosure.

FIG. 8 is a flow chart diagram illustrating an example method for machine-learned inference according to example implementations of aspects of the present disclosure;

FIG. 9 is a flow chart diagram illustrating an example method for training a machine-learned model according to example implementations of aspects of the present disclosure;

FIG. 10 is a block diagram of an example processing flow for using machine-learned model(s) to process input(s) to generate output(s) according to example implementations of aspects of the present disclosure;

FIG. 11 is a block diagram of an example sequence processing model according to example implementations of aspects of the present disclosure;

FIG. 12 is a block diagram of an example technique for populating an example input sequence for processing by a sequence processing model according to example implementations of aspects of the present disclosure;

FIG. 13 is a block diagram of an example model development platform according to example implementations of aspects of the present disclosure;

FIG. 14 is a block diagram of an example training workflow for training a machine-learned model according to example implementations of aspects of the present disclosure;

FIG. 15 is a block diagram of an inference system for operating one or more machine-learned model(s) to perform inference according to example implementations of aspects of the present disclosure;

FIG. 16 is a block diagram of an example networked computing system according to example implementations of aspects of the present disclosure;

FIG. 17 is a block diagram of an example computing device according to example implementations of aspects of the present disclosure; and

FIG. 18 is a block diagram of an example computing device according to example implementations of aspects of the present disclosure.

### DETAILED DESCRIPTION

Generally, the present disclosure is directed to systems and methods for multi-turn collaboration for machine-learned inference operations. More particularly, the present disclosure is directed to systems and methods for multi-turn collaboration to generate and refine a belief state (e.g., belief graph, etc.) associated with a machine learning input, wherein the machine learning input is characterized by some amount of uncertainty (e.g., ambiguity, vagueness, fuzziness, underspecification, implicitness, etc.). For example, a computing system can receive a first input (e.g., natural language input, etc.) associated with a machine-learned inference operation. Based on the first input, the computing system can generate an uncertain first belief state associated with the first input. The computing system can then collaborate with another entity (e.g., human user, etc.) to determine an updated belief state having reduced uncertainty compared to the first belief state. Based at least in part on the updated belief state, the computing system can perform a machine-learned inference operation (e.g., image processing operation such as image generation, image manipulation, etc.).

Collaboration can include, for example, interactively prompting another entity (e.g., user) to provide additional inputs for updating the first belief state. For example, a computing system can select, based on the first belief state, one or more prompting actions for the computing system to perform. A prompting action can include, for example, asking a question about the first input or first belief state; providing (e.g., to a user) an interface (e.g., graphical user interface (GUI)) for updating the first belief state; or other prompting action (e.g., application programming interface (API) call, etc.). Responsive to receiving an additional input, the computing system can update the belief state based on the additional input.

In some instances, a first input can include instruction content or other data indicative of one or more target output properties for the machine-learned inference operation. As a non-limiting illustrative example, in some instances, a machine-learned inference operation may include a generative machine learning operation (e.g., image generation, image editing or other image processing, text generation, audio or video generation, etc.) and the first input may describe one or more entities to be included in a generative output (e.g., image, etc.); one or more attributes of the one or more entities; or one or more relationships between tuples (e.g., pairs, etc.) of entities. In some instances, a belief state can include structured data (e.g., graph-structured data) describing one or more target output properties associated with the first input.

In some instances, a belief state can include a belief state comprising some uncertainty, such as a probability distribution over a plurality of possible sets of beliefs. In some instances, a belief state can include one or more beliefs about a user intent, such as a probability distribution over a plurality of possible ground truth user intents. For example, if a first input describes, with some uncertainty (e.g., vagueness, ambiguity, underspecification, etc.) one or more target output properties (e.g., entities, attributes, relationships, etc.), a belief state can include a probability distribution over a plurality of possible sets of target output properties. As a non-limiting illustrative example, if a first input includes the word “crane,” a first belief state may include a probability distribution comprising a 70 percent chance that the word “crane” refers to a construction crane; a 20 percent chance that the word “crane” refers to a living bird; and a 10 percent chance that the word “crane” refers to an origami paper depiction of a bird. In some instances, a belief state can include one or more conditional probabilities or conditional dependencies. Continuing the non-limiting illustrative example, a belief state may include a first conditional probability that an output should include a “lake” entity if “crane” refers to a living bird; a second conditional probability assuming a construction crane; and a third conditional probability assuming an origami crane.

In some instances, updating a belief state based on an additional input can include updating one or more conditional probabilities based on information learned from the additional input. Continuing the “crane” example, a user may provide an input indicating that “crane” refers to a construction crane. Responsive to receiving the input, the computing system may set a “construction crane” probability to 100 percent; set “origami crane” and “crane bird” probabilities to zero percent; and update one or more other probabilities (e.g., “lake” probability, “hard hat” probability, etc.) based on the updated “crane” beliefs.

In some instances, a language model can be used to generate or update a belief state. For example, in some instances, generating a first belief state can include providing the first input to the language model, along with instruction content to cause the language model to generate all or part of the first belief state based on the first input. For example, the instruction content can include an instruction to list one or more entities, attributes, or relationships described in the first input; list one or more possible entities, attributes, or relationships that are not expressly described but may be implicit in the first input (e.g., image background content such as lakes, buildings, sky, etc.); estimate a probability or confidence associated with one or more beliefs; estimate an importance or salience of one or more entities, attributes, or relationships; or other instruction content. In some instances, updating a belief state based on an additional input can include setting or freezing a first probability based on the additional input (e.g., freezing “construction crane” probability at 100 percent, etc.); inputting data indicative of one or more additional inputs or frozen probabilities to a language model (e.g., along with a first input and instruction content, etc.); and outputting, by the language model, all or part of a new belief state conditioned on the frozen probabilities. However, freezing a first probability is not required. For example, in some instances, updating a belief state can include inputting data indicative of one or more additional inputs to a language model (e.g., along with a first input and instruction content, etc.); and outputting, by the language model, all or part of a new belief state based on the one or more additional inputs.

In some instances, updating the belief state can include a multi-turn collaboration process, wherein the computing system selects and performs a prompting action based on a current belief state; a user or other entity provides additional input responsive to the prompting action; and the computing system updates the belief state based on the additional input.

In some instances, a prompting action can be selected using a machine-learned model, which can be the same as or different from a machine-learned model used to generate the belief state. For example, in some instances, one or more of the first input and the belief state can be provided to a machine-learned model (e.g., language model), along with instruction content to cause the machine-learned model to generate a prompting value (e.g., natural language clarification question, etc.) based on the first input; the machine-learned model can generate the prompting value based on the first input; and the prompting action can include providing the prompting value to a user via a user interface.

In some instances, a prompting action can be selected according to a Markov decision process (e.g., partially observable Markov decision process, etc.). A Markov decision process can include, for example, an agent-based decision-making process, wherein an agent (e.g., the computing system) selects an action (e.g., prompting action, machine-learned inference action, etc.) based on an expected or estimated reward associated with the action. An expected reward can be, for example, an estimate (e.g., heuristic estimate, machine-learned estimate, etc.) of an unknown ground-truth reward value or expected average ground-truth reward value associated with the action. In some instances, a ground-truth reward value can include a numerical reward value based on one or more component values, such as reward or penalty components associated with one or more of: user satisfaction with a machine-learned inference output, belief state accuracy (e.g., compared to a ground-truth user intent or belief, etc.), information gain (e.g., change in belief state accuracy, etc.), number of actions taken (e.g., prompting actions, inference actions, etc.), or other value (e.g., amount of computing resources used, financial cost of computing resources used, etc.). In some instances, a reward can include a sum of a plurality of reward values associated with a plurality of turns taken by a computing system in a multi-turn collaboration, wherein each reward value may be discounted based on a number of turns taken.

In some instances, an expected reward can be determined based on one or more conditional probabilities, such as conditional probabilities associated with a belief state. For example, an expected reward associated with an action can include a weighted sum of rewards associated with a plurality of possible outcomes of the action, with each reward weighted based on a conditional probability of the corresponding outcome. For example, continuing the non-limiting illustrative example above, an expected reward of performing machine-learned inference based on the assumption that “crane” means construction crane may include 0.7 times an expected reward if the assumption is correct; plus 0.2 times an expected reward (or loss) if the word “crane” means a living bird: plus 0.1 times an expected reward (or loss) if the word “crane” refers to an origami paper depiction of a bird.

In some instances, a belief state can include a plurality of beliefs, with each belief being associated with one or more of: a confidence level or uncertainty level (e.g., probability value, etc.); an importance or salience level (e.g., numerical value, etc.); or other relevant metadata. In some instances, a computing system can select a prompting action based at least in part on such confidence levels or importance levels. For example, in some instances, a total entropy associated with a belief can be determined based on one or more confidence levels of the belief according to the formula H=−Σp(x)log p(x). For example, continuing the non-limiting illustrative example, above, an entropy associated with a probabilistic belief about the word “crane” can be equal to −(0.7*log(0.7)+0.2*log(0.2)+0.1*log(0.1)). In some instances, an estimated reward (e.g., estimated information gain, etc.) associated with an action can be determined based on one or more entropy values. For example, in some instances, an estimated information gain reward associated with asking a clarifying question about a probabilistic belief can include a product of an entropy value and one or more importance values associated with the belief (e.g., entity importance*attribute importance*entropy, etc.).

In some instances, a prompting action can include providing an interface (e.g., graphical user interface (GUI), application programming interface (API), etc.) for providing additional input. In some instances, selecting a prompting action can include selecting (e.g., according to a Markov decision process) one or more details of a GUI view based at least in part on a current belief state (e.g., belief graph, etc.). For example, in some instances, a GUI view may include one or more regions (e.g., panes, frames, tabs, etc.) for displaying clarification questions, and an ordering of the questions may be determined based on an expected reward associated with each question. As another example, in some instances, GUI components can be added, omitted, surfaced (e.g., maximized, etc.), or hidden (e.g., minimized, etc.) based at least in part on one or more expected rewards associated with the GUI components. As a non-limiting illustrative example, if a belief state includes very high uncertainty about a single important variable (e.g., “construction crane” probability, etc.), a GUI may choose to display a single question about the variable, with no other GUI content. As another example, if a belief state includes moderate uncertainty about several different variables, a computing system may select a more general GUI view providing a user with a holistic overview of a current belief state (e.g., graph-structured view, sample machine-learned inference outputs, etc.) and a plurality of different belief state editing options. As another example, selecting a prompting action can include surfacing one or more high-expected-reward GUI components (e.g., clarification questions about important or uncertain beliefs, detail view of important or uncertain beliefs, etc.) in an initial GUI view, and hiding lower-expected-reward GUI components from the GUI view (e.g., along with a button to surface the GUI components on user request, etc.).

Example GUI view components that can be included or omitted from a selected GUI view can include a belief state display, such as a graph-structured display of entities and relationships of a current belief state; preliminary machine-learned inference outputs (e.g., generated images, etc.) generated based on a current belief state; interactive components (e.g., mouseover components, clickable components, etc.) a user can interact with to learn additional information (e.g., attributes, confidence levels, importance levels, etc.) about a current belief state; clarification questions (e.g., multiple choice questions with clickable input components, open-ended questions with text input, etc.); various input components (e.g., regenerate/refresh buttons, edit buttons, increase/decrease buttons, text boxes, image selection or editing components, etc.); the first input on which the belief state is based, which can in some instances be marked up or highlighted based on the current belief state; and other GUI components (e.g., Settings tab, History tab, etc.).

An example field of application for the present disclosure can include various machine learning applications, such as image processing applications (e.g., image generation, image editing, imaging, etc.). For example, in some instances, a computing system can receive a first input describing one or more target output properties for a machine-learned image output. Based on the first input, the computing system can generate a first belief state (e.g., using a language model or multimodal model, etc.). The computing system can then collaboratively interact with the user (e.g., according to a Markov decision process, etc.) to update the belief state. The computing system can then provide data indicative of an updated belief state to an image processing model (e.g., text-to-image model, etc.), and the image processing model can perform machine-learned image processing based at least in part on the updated belief state.

In some instances, a belief state (e.g., graph-structured belief state, etc.) can include or be represented as a belief graph. Similarly, in some instances, a GUI for displaying a belief state can include a graph display or other graph-structured component for displaying a belief graph or belief graph data. However, although some examples herein may refer to belief graphs, other belief state data can be used without deviating from the scope of the present disclosure, such as list-structured, table-structured, or hash-table-structured belief state data; natural language belief state data; or other data indicative of a belief state associated with a user input.

Systems and methods according to some aspects of the present disclosure can provide a variety of technical effects and benefits, such as improvements to computing technology (e.g., machine learning technology, etc.). For example, in some instances, systems and methods according to some aspects of the present disclosure can provide improved output quality compared to some alternative implementations. In some instances, systems and methods according to some aspects of the present disclosure can provide outputs of a given quality (e.g., user satisfaction score, etc.) in fewer interactive turns compared to some alternative implementations. As another example, in some instances, systems and methods according to some aspects of the present disclosure can provide outputs of a given quality at a reduced computational cost compared to some alternative methods. As another example, in some instances, systems and methods according to some aspects of the present disclosure can provide improved interpretability of machine-learned inference processes compared to some alternative implementations.

In some instances, systems and methods according to some aspects of the present disclosure can provide improved output quality compared to some alternative implementations. For example, some alternative implementations may include unguided user interactions (e.g., machine-learned inference based solely on an unguided user input, etc.). In such instances, uncertainty (e.g., ambiguity, vagueness, underspecification, etc.) associated with user inputs may cause a machine-learned model to generate inference outputs that do not align with a user's expectations. Advantageously, example implementations according to some aspects of the present disclosure can identify areas of uncertainty and can provided guided user interactions to reduce such uncertainty, thereby producing machine-learned inference outputs that are better aligned with user intent (e.g., having a reduced semantic distance or edit distance from a ground truth user intent, etc.). For example, in some example experiments according to aspects of the present disclosure, systems and methods according to some aspects of the present disclosure provided improved performance compared to single-turn unguided inputs according to several metrics, including image-to-image embedding similarity between a generated image and a ground truth image; image-to-text similarity between a ground truth prompt and a generated image; image-to-text similarity between a ground truth image and a prompt used to generate a generated image; text-to-text similarity between a ground truth prompt and a generated prompt; and text-to-text similarity between a caption generated based on a ground truth image and a caption generated based on a generated image. Further details of some example experiments according to aspects of the present disclosure are provided in “Proactive Agents for Multi-Turn Text-to-Image Generation Under Uncertainty,” available at https://arxiv.org/abs/2412.06771 (last accessed Jan. 16, 2024).

In some instances, systems and methods according to some aspects of the present disclosure can provide machine-learned outputs of a given quality in fewer interactive turns compared to some alternative implementations. For example, some alternative implementations may include unguided user interactions where a user may attempt to alter an input (e.g., natural language input) based on one or more flaws identified in a first machine-learned inference output. However, many users lack prompt engineering expertise, and may not select an optimal updated input based on the provided outputs. Additionally, in some instances, a user may be unable to determine a cause of one or more identified flaws, thereby making it difficult to design an alternate input to try to correct the flaws. Under such alternate implementations, generating a satisfactory inference output may require a large number of interactive turns, with each interactive turn requiring one or more machine-learned inference operations. In contrast, systems and methods according to some aspects of the present disclosure can directly identify one or more sources of uncertainty in an input; display data associated with the sources of uncertainty to a user; and prompt the user to provide input to clarify the most significant sources of uncertainty. Advantageously, directly prompting a user to clarify an identified source of uncertainty can reduce a number of interactive turns required to generate a satisfactory inference output.

In some instances, systems and methods according to some aspects of the present disclosure can provide improved interpretability according to some alternative implementations. For example, some alternative machine-learned inference methods may include “black box” methods that may provide an output based on an input, but may provide little or no other data for understanding how the output was produced, what the output may mean, or other machine learning interpretability data. Advantageously, example systems and methods according to some aspects of the present disclosure can provide a user with data describing one or more intermediate belief states associated with a machine-learned inference process, wherein the intermediate belief states are generated based on one or more units and wherein the machine-learned inference is based at least in part on the intermediate belief states.

In some instances, systems and methods according to some aspects of the present disclosure can provide reduced computational cost compared to some alternative implementations. For example, in some instances, systems and methods according to some aspects of the present disclosure can provide an output of a given quality in a reduced number of interactive turns compared to some alternative methods. In some instances, each interactive turn of some alternative methods may be associated with a computational cost (e.g., electricity cost, memory usage, processor usage, etc.), such as a cost associated with performing a machine-learned inference at each interactive turn. Advantageously, by reducing a number of interactive turns required, systems and methods according to some aspects of the present disclosure can in some instances reduce a computational cost of machine-learned inference compared to some alternative methods. Additionally, in some instances, systems and methods according to some aspects of the present disclosure can select whether or not to perform a machine-learned inference (e.g., based on one or more cost values or reward values of the machine-learned inference) in a given interactive turn, thereby further reducing a computational cost of machine-learned inference compared to some alternative implementations. Additionally, in some instances, systems and methods according to some aspects of the present disclosure can select between one or more lower-computational-cost and one or more higher-computational-cost machine-learned models (e.g., based on one or more cost values or reward values associated with each model) at a given interactive turn, thereby further reducing a computational cost compared to some alternative implementations that may use a single model (e.g., single high-computational-cost model, etc.) for all inferences or interactive turns. Additionally, in some instances, systems and methods according to some aspects of the present disclosure can select a number of inference outputs (e.g., zero, one, two, etc.) to generate (e.g., based on one or more cost values or reward values associated with each model) at a given interactive turn, thereby further reducing a computational cost compared to some alternative implementations that may produce a fixed number of inference outputs at every interactive turn.

Various example implementations are described herein with respect to the accompanying Figures.

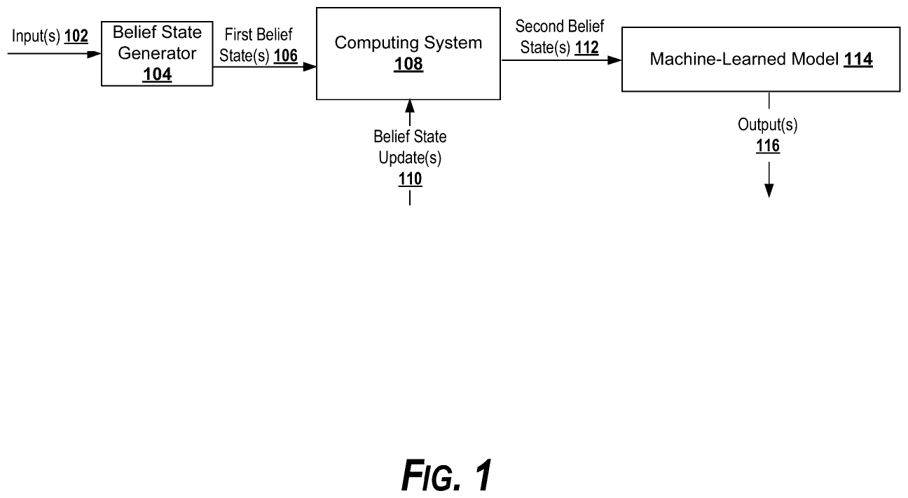

FIG. 1 is a block diagram of an example system for machine-learned inference based on a collaboratively updated belief state according to some aspects of the present disclosure. A belief state generator 104 can receive one or more inputs 102 and generate one or more first belief states 106 based on the input(s) 102. A computing system 108 can receive one or more belief state updates 110 and can update the first belief state(s) 106 based on the update(s) 110 to generate one or more second belief state(s) 112. The computing system can provide data indicative of the second belief state(s) 112 (e.g., inputs generated based on the second belief state(s) 112, etc.) as input to a machine-learned model 114, and the machine-learned model 114 can generate one or more outputs 116 based on the data indicative of the second belief state(s) 112.

Input 102 can generally include or otherwise represent various types of data. Input 102 can include one type or many different types of data. Example data types for input 102 include natural language data (e.g., text, audio, or multimodal natural language data), communication protocol data (e.g., hypertext transfer protocol message, etc.), software code data (e.g., source code, object code, machine code, or any other form of computer-readable instructions or programming languages), or other data type. Data can be raw or processed and can be in any format or schema.

In some instances, an input 102 can include instruction content or other data indicative of one or more target output properties for the machine-learned inference operation. As a non-limiting illustrative example, in some instances, an input 102 can include an instruction to perform, or a machine-learned model 114 may be configured to perform, a generative machine learning operation (e.g., image generation, image editing or other image processing, text generation, audio or video generation, etc.). In some instances, the input 102 may describe one or more entities to be included in an output 116; one or more attributes of the one or more entities; or one or more relationships between tuples (e.g., pairs, groups, sets, etc.) of entities.

A belief state generator 104 can include, for example, a module for generating a belief state 106 based at least in part on an input 102. In some instances, a belief state generator 104 can include one or more machine-learned models configured to generate a belief state. In some instances, a belief state generator 104 can include one or more language models. The belief state generator 104 can include various model architectures, such as various neural network model architectures. An example model architecture for a belief state generator 104 can include a sequence processing model architecture (e.g., a transformer model, selective structured state space model, etc.). For example, the belief state generator 104 can be configured to receive an input sequence and generate an output sequence. For instance, the belief state generator 104 can be configured to generate an output sequence where elements of the output sequence are predicted based on the elements of the input sequence. In some instances, a belief state generator 104 can include a generative sequence processing model, such as a generative natural language model (e.g., text-based, audio-based, multimodal, etc.) or other generative model (e.g., image generation, audio generation, or video generation model, etc.). In some instances, a belief state generator 104 can include a model architecture having an attention mechanism (e.g., self-attention). In some instances, the belief state generator 104 be a pre-trained model (e.g., pretrained using large-scale unsupervised learning). In some instances, the belief state generator 104 can be fine-tuned over one or more fine-tuning datasets, such as a fine-tuning dataset associated with one or more specialized generation tasks. An example fine-tuning dataset can include a dataset comprising a plurality of data examples comprising input-output pairs correlating an input to a belief state associated with the input.

In some instances, a belief state generator 104 can include one or more specialized parsers, such as an entity parser configured to identify one or more entities associated with (e.g., mentioned in, identified by, etc.) an input 102; an attribute parser configured to identify any attributes associated with the input 102 (e.g., attributes of one or more entities mentioned in the input 102, etc.); and a relationship parser configured to identify any relationships between the entities associated with the input 102.

In some instances, a parser can include a machine-learned model (e.g., language model, etc.) that has been prompted with in-context learning content to cause the machine-learned model to parse an input 102 and generate an output indicative of one or more entities, attributes, or relationships. In some instances, in-context learning content can include instruction content, such as one or more instructions to identify entities, relationships, or attributes in an input 102 (e.g., “Given a text-to-image prompt, output a list of entities associated with the prompt, including all of the following: (1) all clearly stated entities within the prompt; (2) potential entities that are implied or strongly suggested by the prompt; and (3) relevant background elements which could impact the image generation from the prompt or context, including weather, location, time of day, mood or atmosphere.”; “Given a text-to-image prompt and a list of entities described in the prompt, identify a list of entity pairs and relationships between them”; “Given a text-to-image prompt and a particular entity described in the prompt, identify a list of possible attributes that could describe the particular entity,” etc.). In some instances, instruction content can include instruction content defining a structured output format, such as a structured format associated with a belief state 106 (e.g., “The output should be a list, and each entry should be formatted as a JSON dict with the following fields: name, importance_to_ask_score, description, entity_type, and probability_of_appearing,” etc.).

In some instances, in-context learning content can include one or more input-output pairs or tuples, such as few-shot prompt content comprising example input-output pairs; chain-of-thought prompt content comprising example input-reasoning-output tuples; or other in-context learning content. For example, an example input-output pair can include an example input (e.g., user input, etc.), and an example output (e.g., comprising one or more of an entity list, relationship list, attribute list, etc.) associated with the example input. The example input can include an input that is different from the input 102, but which shares one or more properties with an input 102. For example, the example input can have a similar (e.g., same) data type (e.g., text, natural language, etc.), similar (e.g., same) content type (e.g., instruction content; entity, relationship, or attribute content; etc.), or other similarities with the input 102. The example output can include, for example, an example output generated by a human annotator; an example output generated by a machine-learned model and selected or scored by a human reviewer; or other example output content.

A belief state 106 can include, for example, data indicative of one or more properties of an input 102, one or more target properties of an output 116, one or more inferred meanings (e.g., inferred meanings associated with a first input 102, etc.), one or more inferred intents or goals (e.g., of a user, of a machine-learned agent, etc.), or other belief state data 106. In some instances, a belief state 106 can include a probability distribution over a plurality of possible values, such as a probability distribution over a plurality of sets of target properties of an output 116; a probability distribution over a plurality of possible meanings of a first input 102; a probability distribution over a plurality of possible intents or goals (e.g., of a user, of a machine-learned agent, etc.); or other probability distribution. In some instances, a first belief state 106 can include a probability distribution over a plurality of possible second belief states 112 associated with the first belief state 106.

In some instances, a belief state 106 can include structured data (e.g., graph-structured data). In some instances, structured data can include graph-structured data, such as node data comprising data associated with a plurality of nodes (e.g., vertices, etc.), and edge data comprising data associated with a plurality of edges of a graph. Graph-structured data can be stored in any manner appropriate for storing node and edge data, such as one or more databases, tables, files (e.g., files having a structured data format such as comma-separated value (CSV), Javascript Object Notation (JSON), extensible markup language (XML), etc.), or other data storage system. Graph-structured data can be displayed in any appropriate manner, such as in a graph-style display or other display format (e.g., list view, table view, tuple view, etc.).

In some instances, a belief state 106 can include structured data describing one or more target output properties associated with an input 102 or output 116. In some instances, a belief state 106 can include data indicative of one or more entities included in a first input 102 or entities to be included in an output 116. In some instances, a belief state 106 can include data indicative of one or more attributes of one or more entities (e.g., attributes included in an input 102, attributes inferred from knowledge about an entity, attributes inferred from other knowledge, etc.). In some instances, a belief state 106 can include data indicative of one or more relationships between tuples (e.g., pairs, 3-tuples, 4-tuples, n-tuples, etc.) of entities (e.g., relationships included in an input 102, relationships inferred from knowledge about an entity or attribute thereof, relationships inferred from other knowledge, etc.), attributes of the relationships, or other data.

In some instances, a belief state 106 can include one or more importance or confidence values associated with one or more data items. For example, in some instances, an entity to be included in an output 116 (e.g., image output, etc.) can be associated with an importance value, such as a numerical importance rating (e.g., on a scale of 1 to 5, 1 to 10, etc.). A numerical importance rating can reflect, for example, an estimated importance of including the entity in the output 116; a salience of the entity in the output 116; an importance of accurately identifying one or more attributes or relationships of the entity; or other aspect of entity importance. Similarly, in some instances, one or more relationships or attributes to be included in an output 116 can be associated with an importance value, such as a numerical importance rating. In some instances, an importance of a relationship or attribute can be the same as, different from, related to, or unrelated to an importance of one or more entities associated with the attribute or relationship. As a non-limiting illustrative example, if an input 102 includes an instruction to generate a circuit diagram of a matrix multiplication unit, the matrix multiplication unit may have high importance (e.g., salience, etc.), while one or more attributes of the matrix multiplication unit may have high or low importance (e.g., irrespective of the importance of the matrix multiplication unit).

In some instances, a belief state 106 can include one or more confidence values associated with one or more data items. For example, in some instances, a belief state 106 can include a probability distribution over a plurality of possible values (e.g., entity values, attribute values, relationship values, belief state 106, 112 values, etc.). In some instances, a confidence associated with a particular value (e.g., entity value, relationship value, relationship value, etc.) can be similar to (e.g., same as) a probability of that value within the probability distribution. As a non-limiting illustrative example, if an input 102 includes an instruction to generate a circuit diagram of a multiplier unit, a probability distribution can include a 40 percent chance that the multiplier unit should be a Wallace tree multiplier, a 30 percent chance that the multiplier unit should be a Dadda multiplier, and so on. Continuing the example, a belief state 106 could include a “Wallace tree” entity or “Wallace tree” attribute with a 40 percent confidence value associated with the “Wallace tree” entity or attribute. A confidence value can be associated with, for example, any data item or combination of data items of a belief state 106. For example, an entity can have a confidence value associated with the entity; an attribute of the entity can have a confidence value associated with the attribute, which can be related or unrelated to a confidence value of the entity; and a relationship between two or more entities can have a confidence value associated with the relationship, which can be related or unrelated to a confidence value of each entity associated with the relationship. In some instances, a confidence value can include or be based on one or more conditional probabilities. For example, in some instances, a confidence value can include a sum of a plurality of associated conditional probabilities. Continuing the above example, a confidence value for an attribute or related entity associated with a multiplier can include a sum of 0.4 times a first conditional probability associated with the attribute given that the multiplier is a “Wallace tree” multiplier; 0.3 times a second conditional probability associated with the attribute given that the multiplier is a Dadda multiplier; and so on.

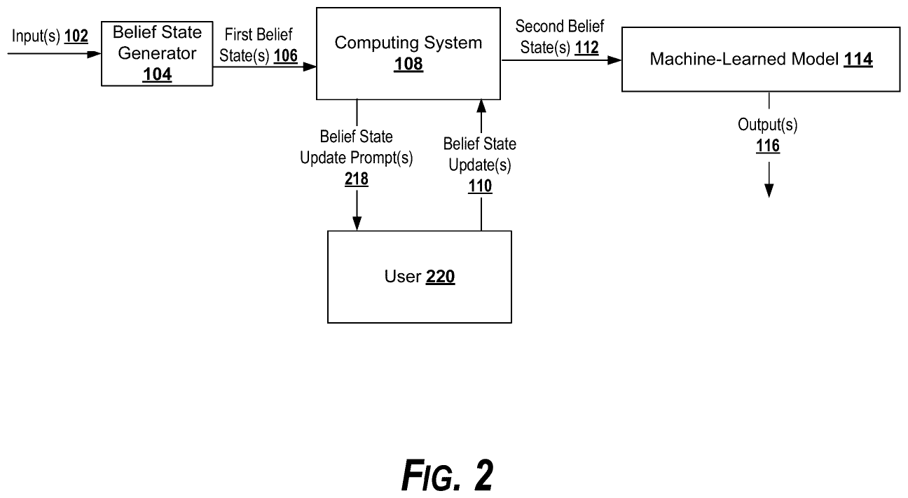

In some instances, a belief state 106 can include a belief graph. For example, in some instances, a belief state can include a graph or graph-structured data indicative of one or more beliefs, such as a graph comprising one or more entities as node(s) of the graph; one or more relationships as edge(s) of the graph; or other data (e.g., graph-structured data, related metadata, etc.). For example, in some instances, any data described herein that can be included in a belief state 106 can be included in or otherwise associated with a belief graph (e.g., as a node, as an edge, as a label associated with a node or edge, as metadata associated with a node or edge, etc.). Similarly, other belief states (e.g., second belief state 112, belief state described herein with respect to FIGS. 2-8, etc.) described herein can include belief graph(s). Similarly, any system or method described herein for generating, displaying, updating, or otherwise processing a belief state (e.g., belief state 106, 112, belief state described herein with respect to FIGS. 2-8, etc.) can include a system or method for generating, displaying, updating, or otherwise processing a belief graph (e.g., belief graph having one or more entities as node(s) and one or more relationships between entities as edge(s), etc.). In some instances, a belief graph can include graph data displayed or stored in a visual format (e.g., image format; display format comprising visual depiction(s) of node(s) and visual depiction(s) of edges, etc.) or in a non-visual format (e.g., Javascript Object Notation (JSON) format, comma-separated value format, ordered tuple format, list of ordered tuples, etc.).

Generating a belief state 106 can include, for example, prompting a machine-learned model (e.g., machine-learned model of a belief state generator 104) based at least in part on the input, and receiving all or part of the belief state as an output of the machine-learned model. For example, in some instances, a machine-learned model (e.g., language model) can be prompted with instruction content to cause the machine-learned model to output data indicative of one or more entities, attributes, or relationships that are expressly identified in the input 102. In some instances, a machine-learned model can be prompted with instruction content to cause the machine-learned model to output data indicative of one or more entities, attributes, or relationships that are not expressly identified in the input. For example, a machine-learned model can be prompted to output data indicative of one or more entities, attributes, or relationships that are implicitly related to entities, attributes, or relationships that are expressly mentioned in an input 102. As another example, a machine-learned model can be prompted to output data indicative of one or more possible entities, attributes, or relationships that are unknown based on the input 102 alone. As a non-limiting illustrative example, a “dog” entity identified in an input 102 may inherently have an unknown “breed,” “size,” or “color” attribute that may be unidentified in the input 102.

In some instances, generating a belief state 106 can include prompting a machine-learned model to generate one or more importance or confidence values. For example, in some instances, a first machine-learned model (e.g., language model) or belief state generator 104 can generate data indicative of a plurality of entities, attributes, or relationships. In some instances, generating a belief state 106 can include, for each entity, attribute, or relationship of the plurality of entities, attributes, or relationships, prompting the first machine-learned model or a second machine-learned model to generate an importance score for the entity, attribute, or relationship (e.g., “How important do you think the ‘multiplier unit’ is to this circuit diagram?”, etc.). In some instances, a second machine-learned model can include a machine-learned model that was trained on importance data (e.g., from human usability studies, etc.), such as a machine-learned model that was trained using a training dataset comprising a plurality of entity-importance pairs (e.g., entity-importance pairs determined based on human studies, provided by human experts, etc.). In some instances, a prompt can be generated based on a prompt template and one or more values (e.g., entity, attribute, or relationship values) identified by the belief state generator 104. For example, in some instances, a first machine-learned model can identify one or more entities, attributes, relationships, output types (e.g., image types, etc.), or other features associated with an input 102. In some instances, the belief state generator 104 can populate a prompt template (e.g., fill-in-the-blank template, such as “How important is the <ENTITY_NAME> to this <OUTPUT_TYPE>?”, etc.) based on the identified features, and can provide the resulting prompt to the first or a second machine-learned model.

In some instances, generating a confidence value can include prompting a machine-learned model to output a confidence value (e.g., as described above with respect to importance values), or can include extracting a confidence value from other values (e.g., embeddings, logit activation values, output values, intermediate layer output values, etc.) generated by a machine-learned model. For example, in some instances, a machine-learned model can include a machine-learned model that generates a plurality of probability values (e.g., softmax probability distribution over an output vocabulary, etc.) associated with a plurality of possible belief values (e.g., attribute values, entity values, relationship values, etc.). In some instances, the plurality of probability values may sum to one or may be normalized to generate a plurality of normalized values that sum to one. In some instances, a confidence value associated with a particular value (e.g., word, token, or phase associated with a vocabulary, etc.) can be determined based on one or more such probability values (e.g., conditional probabilities, etc.). For example, in some instances, a confidence value associated with an entity (e.g., entity having a one-word or one-token name, etc.) can be equal to a token probability associated with the entity. In some instances, a confidence value associated with an entity (e.g., entity having a multi-token or multi-word name, etc.) can be equal to or based on a product of individual probabilities (e.g., token probabilities, word probabilities, etc.). In some instances, a confidence value can be determined using one or more probing techniques (e.g., Gaussian process probe, linear probe, ensembled or bootstrapped probes, etc.). For example, in some instances, a computing system 108 can probe a machine-learned model (e.g., machine-learned model 114, machine-learned belief state generator 104, etc.) with one or more input values associated with a concept (e.g., entity, relationship, attribute, etc.); construct a probability distribution over a plurality of possible classifiers associated with the concept, each classifier generating a class label based on an embedding of the machine-learned model; and determine one or more confidence values or uncertainty values (e.g., entropy values, etc.) based on the probability distribution.

Prompting a machine-learned model to generate all or part of a belief state 106 can include, for example, providing instruction content or question content configured to prompt an appropriate output (e.g., “What entities are mentioned in the following input?”; “Please list all entities mentioned in the following input”; etc.). In some instances, prompting a machine-learned model to generate a belief state 106 can include providing one or more example input-output pairs (e.g., few-shot prompting, chain-of-thought prompting, etc.), such as pairs comprising an example input 102 and an example output associated with a belief state 106. In some instances, an example output of an input-output pair can include an example list of expressly mentioned entities, attributes, or relationships; an example output listing unknown or implicit entities, attributes, or relationships; an example output comprising one or more importance values or confidence values; and the like. In some instances, prompting a machine-learned model to generate all or part of a belief state 106 can include providing a “system prompt” that may be applicable to a plurality of tasks performed by the machine-learned model (e.g., in addition to a respective input prompt for an individual task, etc.). For example, a system prompt can include data about the machine-learned model's role, goals, output formatting instructions, or other system prompt data.

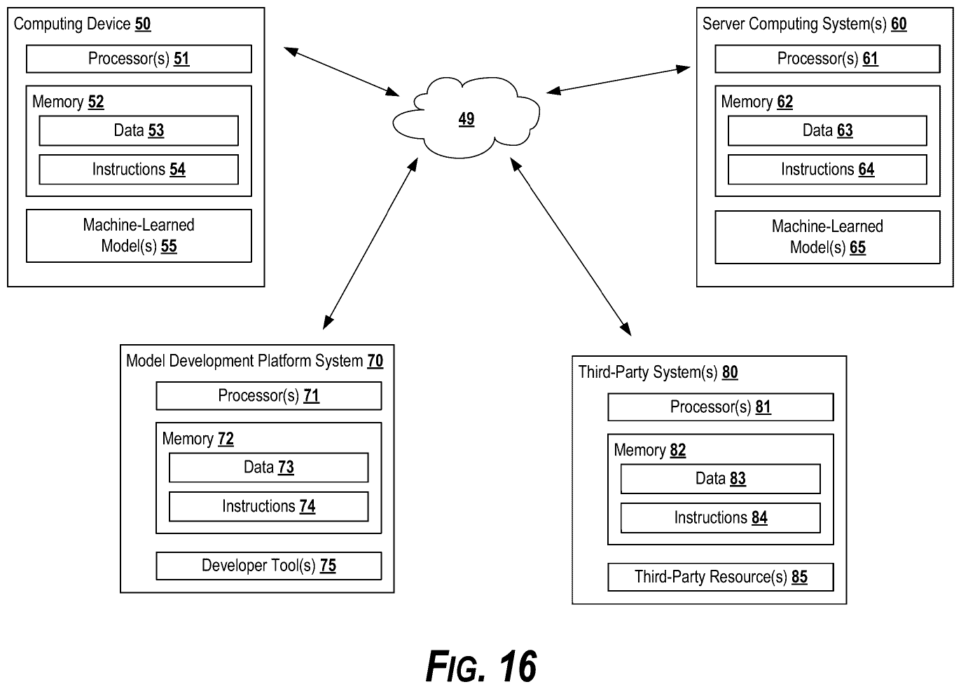

A computing system 108 can be or include one or more software, firmware, or hardware components configured to perform one or more operations described herein. In some instances, the computing system 108 can be, comprise, be comprised by, or share one or more properties with a computing device or system described below with respect to FIGS. 16-18 (e.g., server computing system 60, model development platform system 70, computing device 98, computing device 99, etc.).

A belief state update 110 can include input data associated with a belief state 106, 112. For example, in some instances, a belief state 106, 112 can include data indicative of one or more entities, attributes, or relationships between entities (e.g., associated with or to be included in an output 116; associated with or included in an input 102; etc.), such as data indicative of a selection of one or more entities, attributes, or relationships. In some instances, a belief state 106, 112 can include a probability distribution over a plurality of possible entities, attributes, relationships, belief states 106, 112, or the like. As a non-limiting illustrative example, a belief state 106 based on an input 102 comprising the word “crane” can include a probability distribution over three possible entities or attributes the word “crane” may refer to: a construction crane, a living bird, or an origami paper bird. In such instances, a belief state update 110 can include a selection of one of the three entities. Other types of belief state update 110 data are possible. For example, in some instances, a belief state update 110 can include an adjustment to one or more confidence levels or probabilities of a belief state 106, 112. As a non-limiting illustrative example, a computing system 108 or machine-learned model 114 may in some instances be configured to randomly sample one or more values from a probability distribution associated with a belief state 106 and generate one or more outputs 116 based on the randomly sampled values. In such instances, a belief state update 110 can include one or more values (e.g., values less than or equal to 100 percent, values greater than or equal to zero percent, etc.) for updating one or more sampling probabilities used to generate the one or more outputs 116.

A belief state update 110 can generally include or otherwise represent various types of data. A belief state update 110 can include one type or many different types of data. Example data types for a belief state update 110 include interface interaction data (e.g., data indicative of one or more mouse clicks, GUI interaction data, data indicative of an application programming interface interaction, etc.), natural language data (e.g., text, audio, or multimodal natural language data), communication protocol data (e.g., hypertext transfer protocol message, etc.), software code data (e.g., source code, object code, machine code, or any other form of computer-readable instructions or programming languages), or other data type. Data can be raw or processed and can be in any format or schema.

A second belief state 112 can be, comprise, be comprised by, or otherwise share one or more properties with a first belief state 106. For example, a second belief state 112 can have any property described above with respect to a first belief state 106. A second belief state 112 can have one or more updated values that are the same as or different from a value of a corresponding first belief state 106 from which the second belief state was generated. In some instances, a second belief state can have one or more frozen belief state values (e.g., entities, attributes, relationships, etc.). For example, in some instances, one or more confidence values can include values that have been frozen based on one or more previous belief state updates 110 received by the computing system 108 and used to update a belief state 106, 112. In some instances, a frozen value can include a value that is designated (e.g., flagged, selected, reserved, etc.) as a value that should not be changed in response to future belief state updates 110.

Although FIG. 1 depicts belief states 106, 112 as belief states, other belief state 106, 112 data can be used without deviating from the scope of the present disclosure, such as list-structured, table-structured, or hash-table-structured belief state data; natural language belief state data; or other data indicative of a belief state associated with a user input.

In some instances, determining a second belief state 112 can include generating a second belief state 112 based at least in part on the belief state update 110 and one or more of the input 102 and first belief state 106. In some instances, determining a second belief state 112 can include setting one or more values of a second belief state 112 (e.g., entity values, attribute values, relationship values, importance values, confidence values, etc.) to correspond to a value received from a user 220 via a belief state update 110. In some instances, determining a second belief state 112 can include setting a confidence value associated with a value of a second belief state (e.g., confidence associated with an entity, attribute, or relationship value, etc.) to 100 percent (e.g., in instances where a user selects, confirms, or otherwise provides an entity, attribute, or relationship value via a belief state update 110, etc.).

In some instances, determining one or more second belief states 112 can include freezing one or more values (e.g., entity, attribute, or relationship values) provided by a user via one or more belief state updates 110. For example, in some instances, a computing system 108 may generate a second belief state 112 based on a first belief state update 110 and one or more of a first belief state 106 and input 102. In some instances, the user 220 may later provide a second belief state update 110. In some instances, the computing system 108 may generate a third belief state 106, 112 based in part on the first belief state update 110, second belief state update 110, and one or more of the input 102, first belief state 106, and second belief state 112. In some instances, generating the third belief state may include freezing one or more values (e.g., entities, relationships, or attributes) provided in the first belief state update 110; freezing one or more confidence values at zero or 100 percent based on values provided in the first belief state update; setting (e.g., freezing) one or more values of the third belief state 106, 112 based on the second belief state update 110 (e.g., without modifying the values frozen according to the first belief state update 110); and determining one or more other values for the third belief state 106, 112 based at least in part on the frozen values. More generally, in response to receiving an additional belief state update 110, a computing system 108 can leave one or more frozen values unchanged; set one or more additional values according to an express user input of the additional belief state update 110 (e.g., set a confidence value to 100 percent based on a user selection, etc.); and further update (e.g., using a belief state generator 104, Bayesian network, etc.) any unfrozen values of the second belief state 112 based at least in part on the frozen values, updated values, or input 102. In some instances, a frozen value can be unfrozen by an express user interaction. As a non-limiting illustrative example, if a user sets a “type” attribute of a “multiplier” entity to “Wallace tree,” the computing system 108 can freeze the “type” attribute to “Wallace tree” with 100 percent confidence and process future belief state updates 110 based on the frozen value. However, if the user subsequently resets the “type” attribute to “Dadda” multiplier, the computing system 108 can “unfreeze” the “Wallace tree” value; set the “type” attribute to “Dadda” at 100 percent confidence; and freeze the “Dadda” and 100 percent confidence values. However, freezing probabilities of a belief state 106 is not required. For example, in some instances, updating a belief state can include inputting data indicative of one or belief state updates 110 (e.g., along with an input 102 and in-context learning content, etc.) to a belief state generator 104 or machine-learned model (e.g., language model or multimodal model that is the same as or different from the machine-learned model 114, etc.); and outputting, by the belief state generator 104 or machine-learned model, all or part of a new belief state based on the one or more additional inputs.

In some instances, one or more values that are not directly provided via a belief state update 110 may be updated (e.g., by a computing system 108, belief state generator 104, etc.) based at least in part on values that are provided via a belief state update 110. In some instances, updating a value based on a provided value can include providing, as input to a machine-learned model (e.g., language model), data indicative of the value provided via the belief state update 110. For example, in some instances, a computing system 108 can input, to a machine-learned model (e.g., language model), data (e.g., structured data such as graph-structured data, tuple data, JSON data, XML data, or the like) indicative of one or more values provided via a belief state update 110. In some instances, a computing system 108 can further provide, as input to the machine-learned model, the input 102 and additional content, such as instruction content or other input content configured to cause the machine-learned model to generate one or more belief state 112 values (e.g., entity, attribute, relationship, confidence, or importance values, etc.) based at least in part on the belief state update 110 values and the input 102. In some instances, one or more prompts for generating updated values can be similar to (e.g., same as, etc.) one or more prompts for generating initial values of a first belief state 106 based solely on an input 102. For example, in some instances, input content for generating a second belief state 112 value can include any input content described above for generating a first belief state 106 value. In some instances, a prompt for generating a second belief state 112 value can be the same as or different from a prompt for generating a first belief state 106 value. As a non-limiting illustrative example, in some implementations, a prompt comprising one or more example input-output pairs (e.g., few-shot prompt, chain-of-thought prompt, etc.) may include example inputs that may include or not include example structured data indicative of an example belief state update 110 depending on whether the prompt is being used to generate a first belief state 106 based on an input 102 (e.g., without any belief state updates 110) or being used to generate a second belief state 112 based at least in part on one or more belief state updates 110.

In some instances, generating a second belief state 112 may include generating new values (e.g., confidence values; importance, entity, attribute, or relationship values; etc.) for some or all aspects (e.g., entities, attributes, relationships, etc.) of a belief state 106, 112. For example, in some instances, a belief state generator 104 may freeze any values provided via one or more belief state updates 110, and may generate all other values of a belief state 106, 112 from scratch based at least in part on the belief state updates 110. In some instances, such values may be generated based at least in part on an input 102 associated with the belief state updates 110. In some instances, such values may be generated with or without regard to (e.g., based in part on or not based on, etc.) any previously generated values of a previous belief state 106, 112. In some instances, a belief state generator 104 may only generate new values for some, and not all, aspects of a belief state 106, 112. For example, in some instances, generating a second belief state update 112 based on a belief state update 110 can include providing, to a machine-learned model, data indicative of the belief state update 110 along with instruction content to cause the machine-learned model to identify one or more aspects (e.g., entities, attributes, relationships, etc.) of a first belief state 106 that are likely or unlikely to depend on (e.g., be correlated with, have a conditional probability that depends on, etc.) or be affected by the belief state update 110 values. In some instances, a belief state generator 104 may update one or more values identified as likely to be affected by the belief state update 110 (e.g., values with a likelihood above a likelihood threshold, etc.) and may leave unchanged one or more values identified as unlikely to be affected by the belief state update 110. As a non-limiting illustrative example, if an input 102 includes a “dog” entity, and a belief state update 110 indicates that a “size” attribute of the “dog” entity is “large,” then one or more probabilities associated with a “breed” attribute of the “dog” entity (e.g., chihuahua probability, Saint Bernard probability, etc.) may be identified (e.g., by a machine-learned language model, etc.) as likely to be affected by the belief state update 110, while one or more other attributes (e.g., color, etc.) of the “dog” entity, or one or more other entities or relationships (e.g., “house” entity, etc.) may be identified as unlikely to be affected by the belief state update 110. Continuing the example, a belief state generator 104 may generate new confidence values or other values associated with the “breed” attribute, and may leave one or more other values unchanged (e.g., entity, attribute, and confidence values associated with house entity; attribute and confidence values associated with color attribute; etc.).

In some instances, one or more updated values associated with a second belief state 112 can be generated without the use of a machine-learned model. For example, in some instances, a first belief state 106 may include a probability distribution (e.g., Bayesian network, etc.) comprising one or more conditional probabilities. In some instances, a conditional probability can include a probability associated with a first data item (e.g., first attribute, entity, or relationship) that is conditionally dependent on a value of a second data item (e.g., second attribute, entity, or relationship) associated with a belief state 106, 112. In such instances, determining a value (e.g., confidence value; entity, attribute, relationship, or importance value; etc.) of a belief state 112 can include setting a probability (e.g., confidence value) associated with a first data item (e.g., entity, attribute, relationship, etc.) equal to a conditional probability associated with the first data item given a value (e.g., value associated with a second data item correlated with the first data item) provided by the user 220 via a belief state update 110. In some instances, determining a value of a belief state 112 can include propagating the belief state update 110 through a Bayesian network of a belief state 106, 112.

In some instances, a second belief state 112 can include or be determined based on a merged prompt comprising the input 102 and data indicative of a belief state update 110. For example, in some instances, a computing system 108 can provide, to a second machine-learned model (e.g., language model or multimodal model that is the same as or different from the machine-learned model 114, etc.), input context comprising data indicative of a belief state update 110; and the machine-learned model can generate, based on the input context, a summary of the belief state update 110. In some instances, a computing system 108 can provide, to the second machine-learned model or a third machine-learned model (e.g., language model or multimodal model that is the same as or different from the machine-learned model 114, etc.), second input context comprising the summary and all or part of the input 102, and the third machine-learned model can generate a merged prompt based on the second input context. In some instances, the input context and second input context can include in-context learning context to cause the machine-learned model(s) to generate the summary or the merged prompt, such as instruction content (e.g., “Here is the chat history: question: <question provided to a user>answer: <data indicative of belief state update 110 received from the user>. Turn the question and answer into a single declarative sentence that describes the answer and is not phrased as a question, such as ‘The fire truck in the image is red.’”; “You are writing a prompt for a text-to-image model. The original prompt is <copy of input 102>. The user has provided some additional information: <data indicative of belief state update 110>. Please merge the additional info into the prompt, without changing the original prompt or adding any new information.”; etc.) or other in-context learning content. In some instances, a merged prompt can be provided to a belief state generator 104 to generate a second belief state 112 having a structured format similar to (e.g., same as) a structured format of the first belief state 106.

Although FIG. 1 depicts a machine-learned model 114 generating an output 116 based on a second belief state 112, the machine-learned model 114 can generate the output 116 based on input data having any input format, including a format that is different from a format of the first belief state 106. For example, in some instances, the first belief state 106 can include graph-structured belief state data, and the machine-learned model 114 can generate an output 116 based on a merged natural language prompt, such as a merged natural language prompt comprising the input 102 and additional natural language content (e.g., text content) summarizing one or more belief state updates 110. Other implementations are possible.

In some instances, a machine-learned model 114 can include one or more machine-learned models. The machine-learned model 114 can include various model architectures, such as various neural network model architectures. An example model architecture for a machine-learned model 114 can include an image processing model (e.g., imaging model, image editing model, image generation model, etc.). In some instances, an example image processing model architecture can include one or more of various image processing architectures (e.g., diffusion architecture, generative transformer architecture, variational autoencoder architecture, generative adversarial network architecture, convolutional neural network architecture, etc.). In some instances, a machine-learned model 114 can include a sequence processing model architecture (e.g., a transformer model, selective structured state space model, etc.). For example, the machine-learned model 114 can be configured to receive an input sequence and generate an output sequence (e.g., pixel sequence, etc.) or output image. For example, the machine-learned model 114 can be configured to receive one or more inputs comprising a language input (e.g., text input, etc.) and output one or more images based on the inputs. In some instances, the machine-learned model 114 can be configured to generate an output sequence where elements of the output sequence are predicted based on the elements of the input sequence. In some instances, a machine-learned model 114 can include a generative sequence processing model, such as an image generation model or other generative model (e.g., natural language model generation, audio generation, or video generation model, etc.). In some instances, a machine-learned model 114 can include a model architecture having an attention mechanism (e.g., self-attention). In some instances, the machine-learned model 114 be a pre-trained model (e.g., pretrained using large-scale unsupervised learning, such as based on a training dataset of text-image pairs). In some instances, the machine-learned model 114 can be fine-tuned over one or more fine-tuning datasets, such as a fine-tuning dataset associated with one or more specialized generation tasks. An example fine-tuning dataset can include a dataset comprising a plurality of data examples comprising input-output pairs correlating text inputs or structured belief state inputs to image outputs. In some instances, a fine-tuning data set can include a dataset correlating one or more inputs generated at least in part using a belief state generator 104 to one or more corresponding outputs. In some instances, the machine-learned model 114 can be trained separately from or jointly with a machine-learned belief state generator 104.

An output 116 can generally include or otherwise represent various types of data. An output 116 can include one type or many different types of data. Outputs 116 can be data of the same type(s) or of different types of data as compared to input(s) 102. Example data types for an output 116 can include various kinds of image data, such as compressed or uncompressed image data, binary or text-based image metadata, machine-learned semantic embeddings associated with an image, or the like. Example images can include illustrations, drawings, charts, photorealistic image data, visual representations of non-visual data, etc. Visual representations of non-visual data can include, for example, medical imaging, radar imaging, chemical imaging, audio spectrograms, etc. An output 116 can include, for example, image data such as pixel values, etc. An output 116 can include, for example, image metadata such as an image category, description, classification, or other metadata.

In some instances, generating an output 116 can include generating, by the computing system 108, one or more input values (e.g., prompts, etc.) for the machine-learned model 114 based on a second belief state 112; providing, by the computing system 108, the input values to the machine-learned model 114; and generating, by the machine-learned model 114 based on the input values, an output 116. In some instances, an input value can include a new input value generated solely based on a second belief state 112, an updated input value generated based in part on a first input 102, or other input value.

In some instances, generating an input value can include sampling from a probability distribution associated with a belief state 112. For example, in some instances, a belief state 112 may include one or more entities, attributes, relationships, or other items having a plurality of possible values, with each possible value having a respective probability. In some instances, the plurality of possible values may sum to 1. In some instances, the plurality of possible values may include a softmax probability distribution. In some instances, sampling from such a probability distribution can include assigning each possible value to a range of values between zero and one, the range having a size equal to a probability associated with the possible value; generating a random or pseudorandom number between zero and one; and selecting the value assigned to the random or pseudorandom number. In some instances, generating an input value can include independently sampling a plurality of entities, attributes, relationships, or other items (e.g., without respect to conditional probabilities, dependencies, or the like) or can include a sampling chain that accounts for dependencies between items. For example, in some instances, a first item can be sampled; one or more probability distributions of the second belief state 112 can be updated (e.g., using a machine-learned model, using a Bayesian network, using one or more methods described above with respect to processing a belief state update 110, etc.); a second item can be sampled from the updated probability distribution; one or more probability distributions can be updated based on the second item; and so on. In some instances, an input value can be generated based on the items sampled. As a non-limiting illustrative example, if an input 102 comprises a text input saying “please generate a circuit diagram of a multiplier,” generating an input value to provide to a machine-learned model 114 can include sampling, from a probability distribution comprising a plurality of possible multiplier attributes, a “Wallace tree” attribute; generating a second input value based on the sampled value (e.g., “circuit diagram of a Wallace tree multiplier,” etc.); and providing the second input value to the machine-learned model 114.

FIG. 2 is a block diagram of an example system for machine-learned inference based on a collaboratively updated belief state according to some aspects of the present disclosure. A belief state generator 104 can receive one or more inputs 102 and generate one or more first belief states 106 based on the input(s) 102. A computing system 108 can provide one or more belief state update prompts 218 to a user 220, and can receive one or more belief state updates 110 from the user 220 based on the prompts 218. The computing system can update the first belief state(s) 106 and provide input data based on one or more second belief state(s) 112 as input to a machine-learned model 114, and the machine-learned model 114 can generate one or more outputs 116 based on the input data.

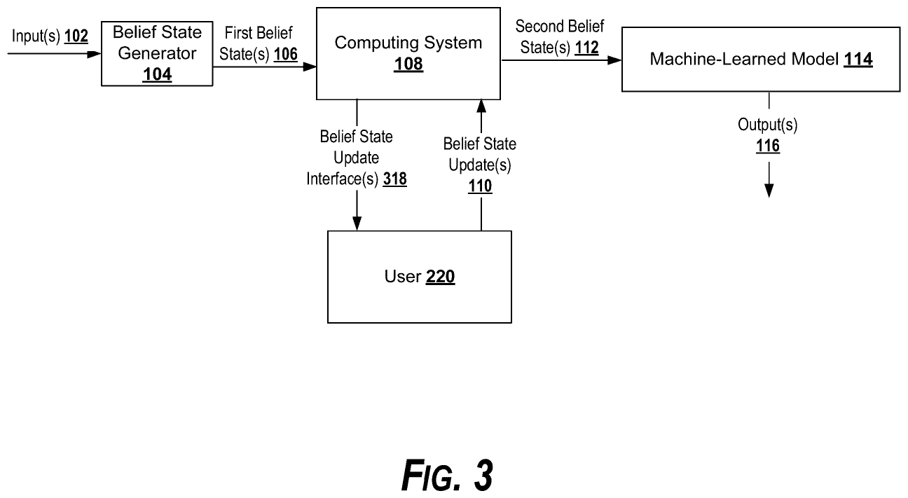

A belief state update prompt 218 can include, for example, an output provided to a computing system, user 220, or other entity to cause the entity to provide data indicative of a belief state update 110. For example, in some instances, a belief state update prompt 218 can include a request (e.g., user request, hypertext transfer protocol (HTTP) request, API request, etc.) to provide data associated with a belief state 106, 112; data associated with an input 102; or other belief update 110 data. In some instances, a belief state update prompt 218 can include one or more questions (e.g., to a user 220) about the input 102 or about one or more aspects of a belief state 106, 112. For example, in some instances, a belief state 106, 112 can include a probability distribution over a plurality of possible beliefs, and a belief state update prompt 218 can include a request (e.g., question, etc.) to provide data about one or more uncertain beliefs (e.g., beliefs associated with a probability greater than zero percent but less than 100 percent). In some instances, a belief graph prompt 218 can include or be included in an interface interaction (e.g., GUI view, dialog box, command-line interface question, etc.) to cause a user 220 to provide data indicative of a belief state update 110. Further details of some example interface interactions associated with a belief state update prompt 218 are provided below with respect to FIGS. 3-4 and 6-7.

In some instances, a belief state update prompt 218 can be generated using one or more machine-learned models (e.g., language models, etc.). For example, in some instances, a computing system can provide, to a second machine-learned model (e.g., language model or multimodal model that is the same as or different from the machine-learned model 114, etc.), the input 102, and the second machine-learned model can generate one or more belief state update prompts 218 based at least in part on the input 102. In some instances, the computing system can provide, to the machine-learned model (e.g., along with the input 102, etc.), in-context learning content to cause the machine-learned model to generate one or more belief state update prompts 218. In-context learning content can include, for example, instruction content, few-shot prompt content comprising example input-output pairs, chain-of-thought content comprising example input-reasoning-output tuples, or other in-context learning content. For example, in some instances, in-context learning content can include one or more instructions to generate a belief state update prompt 218 (e.g., “The original prompt was: <copy of input 102>. Based on the original prompt, please provide a concise and direct question to ask about the image to learn more about the attributes, contents, objects, spatial layout, and style of the image.”; “The chat history is: <copy of input 102> <copy of one or more prior user interactions comprising a belief state update prompt 218 and corresponding belief state update 110>. Based on the chat history, please provide a concise and direct question to ask about the image to learn more about the objects in the image, along with their attributes, relationships between objects, or other relevant information.”; etc.).

As another example, in some instances, a computing system 108 can provide, to a second machine-learned model (e.g., language model or multimodal model that is the same as or different from the machine-learned model 114, etc.), data indicative of a current belief state 106, 112, and the second machine-learned model can generate one or more belief state update prompts 218 based at least in part on the belief state 106, 112. In some instances, the computing system 108 can provide, to the second machine-learned model, in-context learning content (e.g., along with a belief state 106, 112, etc.) to cause the second machine-learned model to generate a belief state update prompt 218, such as instruction content (e.g., “The user described the image as <copy of input 102>. The following is your belief of what the image contains, including the entities, attributes of each entity, and relationships between entities: <copy of first belief state 106>. Please ask the most important clarification questions to make sure you understand the key features of the image.”, etc.) or other in-context learning content. In some instances, in-context learning content can further include explanatory content (e.g., natural language text content, etc.) explaining how the provided data indicative of the belief state 106 is structured (e.g., “Each entity has a list of attributes. Each attribute has a ‘name,” an ‘importance to ask score,’ and ‘candidates.’ ‘Importance to ask score’ is how important it is to ask about the exact value for the attribute. ‘Candidates’ is a list of possible values for the attribute.”; etc.), or other in-context learning content.

In some example experiments according to aspects of the present disclosure, various methods for generating belief state update prompts 218 were tested. In the example experiments, various tested methods according to aspects of the present disclosure provided better performance (e.g., higher VQAScore, higher image-to-image similarity between an image generated by machine-learned model 114 and a ground truth image, etc.) compared to generating outputs 116 based solely on an input 102 or first belief state 106. Additionally, in the example experiments, methods using machine-learned generation of belief state update prompts 218 (e.g., machine-learned generation based on an input 102, such as machine-learned generation without directly providing a first belief state 106 to a second machine-learned model) outperformed non-machine-learned selection of belief state update prompts 218 in some instances.

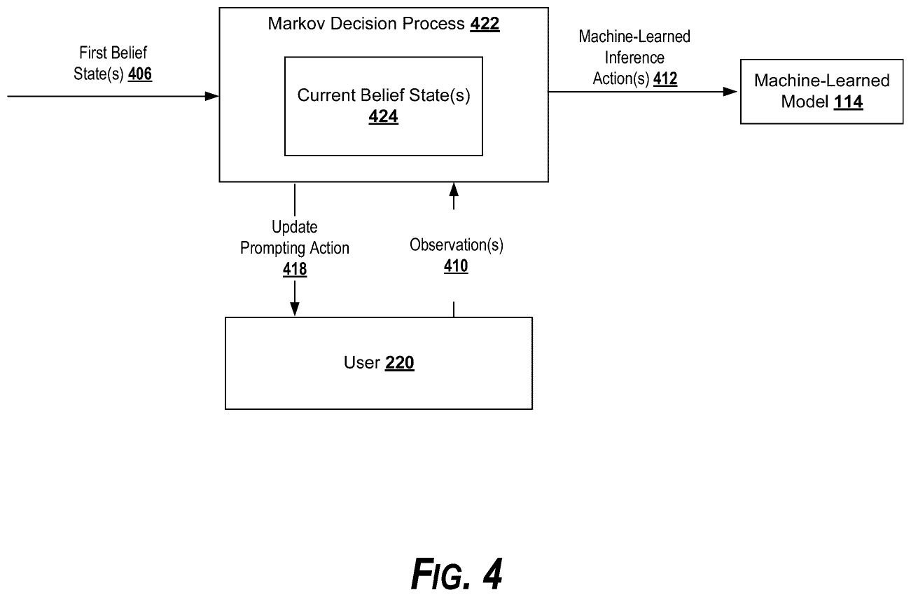

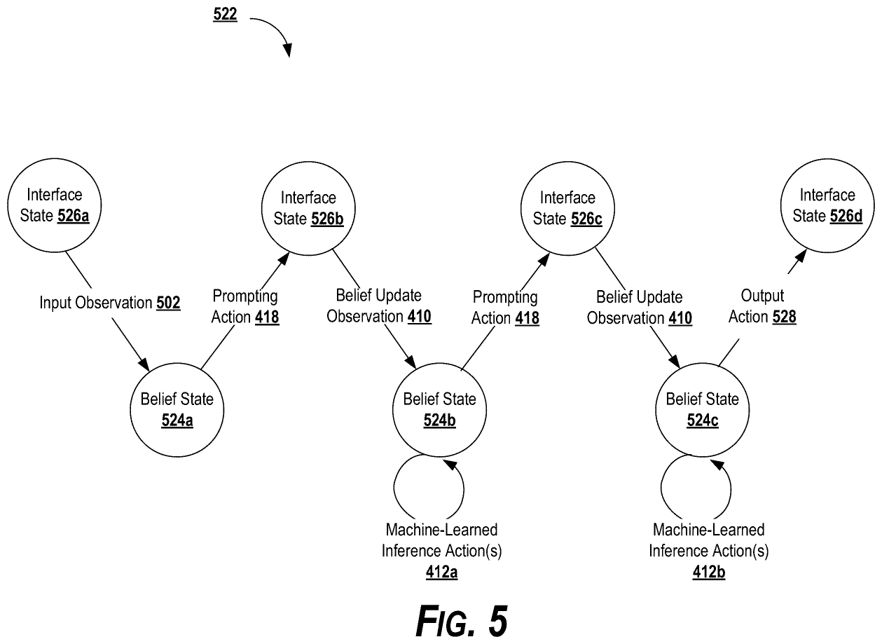

In some instances, a belief state update prompt 218 can be selected (e.g., from a plurality of possible belief state update prompts 218) to optimize an objective function (e.g., maximize a reward function, minimize a loss function, etc.) associated with one or more outputs 116 or a process for generating the one or more outputs. For example, in some instances, a belief state update prompt 218 can be selected according to a Markov decision process to maximize a reward (e.g., overall reward, cumulative reward, etc.) associated with a multi-turn user interaction for generating one or more outputs 116. Further details of an example Markov process for selecting one or more belief state update prompts 218 are provided below with respect to FIGS. 4 and 5.

FIG. 3 is a block diagram of an example system for machine-learned inference based on a collaboratively updated belief state according to some aspects of the present disclosure. A belief state generator 104 can receive one or more inputs 102 and generate one or more first belief states 106 based on the input(s) 102. A computing system 108 can provide one or more belief state update interfaces 218 to a user 220, and can receive one or more belief state updates 110 from the user 220 based via the interface(s) 318. The computing system can update the first belief state(s) 106 and provide data indicative of one or more second belief state(s) 112 as input to a machine-learned model 114, and the machine-learned model 114 can generate one or more outputs 116 based on the second belief state(s) 112.

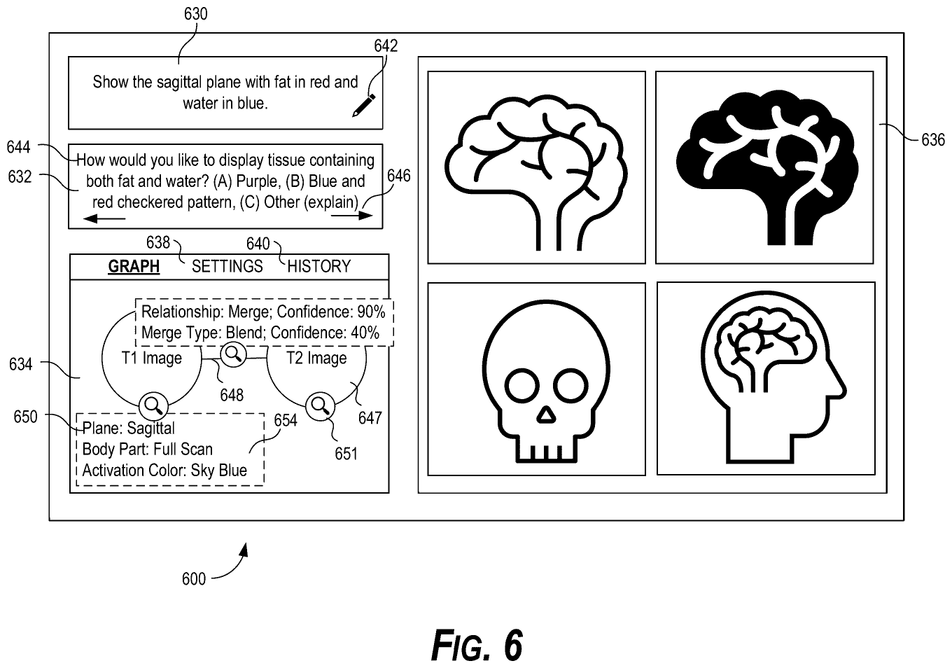

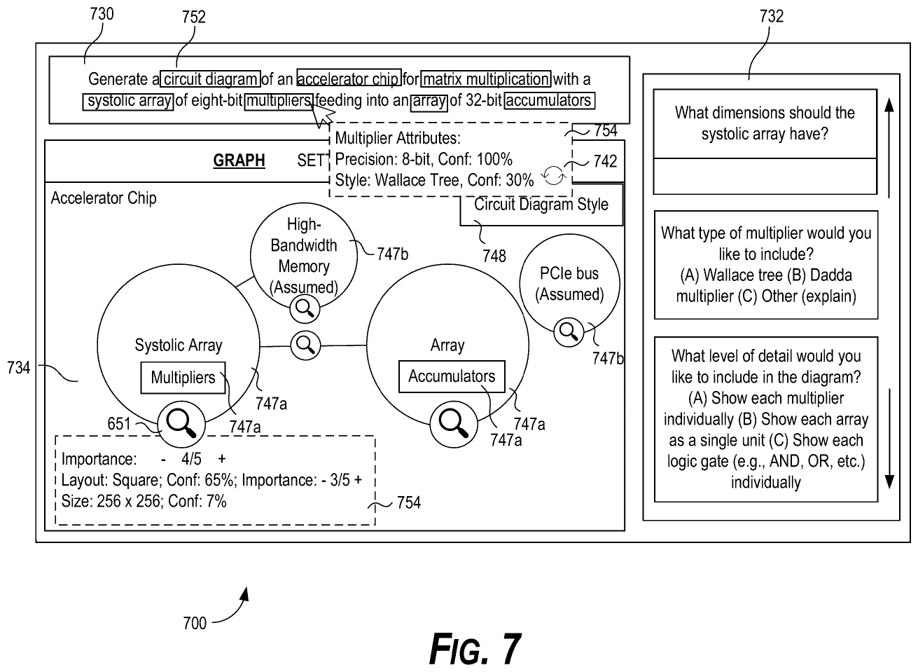

A belief state update interface 218 can be, comprise, be comprised by, or otherwise share one or more properties with a belief state update prompt 218. For example, in some instances, a belief state update interface 218 can have any property described above with respect to a belief state update prompt 218 and vice versa. In some instances, a belief state update interface 218 can include an interface comprising a plurality of mechanisms for updating a plurality of beliefs (e.g., entities, relationships, attributes, etc.) of a belief state 424. For example, in some instances, a belief state update interface 218 can include a GUI comprising a plurality of respective input components for editing or otherwise updating each of a plurality of respective beliefs. In some instances, a belief state update interface 218 can include an open-ended or user-directed GUI interaction, such as a GUI that may allow a user 220 to choose whether to update zero, one, or many beliefs of a first belief state 106. In some instances, a belief state update interface 218 can display one or more (e.g., some or all) beliefs of a first belief state 106 to a user 220. Further details of some example GUIs for receiving a belief state update 110 are provided below with respect to FIGS. 6 and 7.

FIG. 4 is a block diagram of an example system for machine-learned inference based on a collaboratively updated belief state according to some aspects of the present disclosure. A Markov decision process 422 can receive a first belief state 406. The Markov decision process 422 can select, at each of a plurality of iterations, one or more actions 412, 418 to perform based on a current belief state 424. An action 412, 418 can include, for example, an update prompting action 418 or a machine-learned inference action 412. An update prompting action 418 can include, for example, providing a prompt 218, 318 to a user and subsequently performing an observation 410 of one or more inputs (e.g., belief state update 110 inputs, etc.) from a user 220. A machine-learned inference action 412 can include, for example, providing data indicative of a current belief state 424 to a machine-learned model 114 to cause the machine-learned model to generate an output 116 based on the current belief state 424.

In some instances, a first belief state 406 can be, comprise, be comprised by, or otherwise share one or more properties with a first belief state 106. For example, in some instances, a first belief state 406 can have any property described herein with respect to a first belief state 106, and vice versa.

An observation 410 can include, for example, an observation of one or more inputs received by a computing system 108 (e.g., from a user 220), one or more actions (e.g., user 220 actions) detected or observed by the computing system 108, or other observations (e.g., sensor observations, web retrieval observations, etc.). In some instances, performing an observation 410 can include receiving a belief state update 110. In some instances, an observation can be, comprise, be comprised by, or otherwise share one or more properties with a belief state update 110. For example, in some instances, an observation 410 can have any property described above with respect to a belief state update 110. In some instances, an observation 410 can include an observation associated with a Markov decision process (e.g., partially observable Markov decision process, modified partially observable Markov decision process, etc.), such as an observation of a Markov decision process comprising one or more states, observations, actions, transitions, and rewards.

In some instances, a Markov decision process comprising states, observations, actions, transitions, and rewards can include a process for selecting one or more actions 418, 412 based on one or more estimated rewards associated with the actions 418, 412. For example, a Markov decision process can include a plurality of states (e.g., belief states 406, 112, 424) in a state space. In some instances, each state can be characterized by one or more transitions to another state (e.g., belief state 406, 112, 424) responsive to one or more actions 418, 412 or observations 410. As a non-limiting illustrative example, a first belief state 106 having a “Wallace tree multiplier” attribute or entity associated with a confidence value of 40 percent may transition, responsive to an observation 410 comprising confirmation from a user 220 that an output 116 should include a Wallace tree multiplier, to a second belief state 112 having a confidence value of 100 percent associated with the “Wallace tree multiplier” entity or attribute. Similarly, the first belief state 106 having the “Wallace tree multiplier” attribute or entity associated with the confidence value or 40 percent may transition, responsive to an observation 410 comprising input from a user 220 indicating that an output 116 should not include a Wallace tree multiplier, to a second belief state 112 having a confidence value of zero percent associated with the “Wallace tree multiplier” entity or attribute. As another example, a transition can include a transition, responsive to a prompting action 418, from a belief state 406, 112, 424 to a waiting-for-input or waiting-for-observation state, wherein a computing system 108 waits to receive (e.g., from a user 220) or otherwise perform an observation 410. In such instances, a transition can include a transition, responsive to receiving an observation 410, from a waiting-for-observation state to a belief state 112, 424. As another example, a transition can include a transition, responsive to a machine-learned inference action 412, from a belief state 406, 112, 124 to an output state, wherein a computing system 108 provides an output 116 to a user 220.

In some instances, one or more states (e.g., output states following a machine-learned inference action 412; waiting-for-observation states; belief states 406, 112, 424; etc.) may be associated with one or more reward values (e.g., immediate reward value associated with the state itself; anticipated future reward value associated with one or more transitions associated with the state; etc.). In some instances, a reward value can include a ground truth reward value or an estimated reward value (e.g., machine-learned estimate, heuristic estimate, etc.). In some instances, a Markov decision process 422 can select one or more actions 412, 418 based on an estimated reward value associated with the actions 412, 418.

In some instances, a Markov decision process 422 can be represented as a graph having states (e.g., belief states 406, 112, 424, etc.) as nodes (e.g., vertices, etc.) and transitions as edges between the vertices. An example graph representation of an example Markov decision process is further described below with respect to FIG. 5.

An objective function (e.g., reward function, loss function, etc.) used to select an action can include, for example, a combination (e.g., sum, etc.) of one or more reward values or loss values. In some instances, a reward value can include a similarity metric, such as a metric of similarity between a ground truth user intent and a belief state (e.g., second belief state 112) used to generate an output 116; between a ground truth user intent and an input value (e.g., text input for a text-to-image model, etc.) determined based on a belief state 406, 112, 424 and provided to a machine-learned model 114; between a ground-truth output and an output 116; between a ground-truth user intent and an output 116; or other similarity metric. In some instances, a similarity metric can include a distance metric, such as edit distance, divergence metric (e.g., Kullback-Liebler divergence, etc.), or other distance metric. In some instances, a similarity metric can include a likelihood metric, such as a log likelihood of a ground truth user intent given a probability distribution of a belief state 106, 112, 424. In some instances, a similarity metric can include a multimodal similarity metric, such as a Contrastive Language-Image Pretraining (CLIP) score for text-to-image similarity or other multimodal similarity metric (e.g., contrastive mode-mode metric, etc.).

In some instances, an objective function (e.g., reward function, loss function, etc.) can include one or more loss values or cost values. In some instances, a loss value can include a fixed loss value associated with a particular action or set of actions (e.g., loss of 1.0 units for each prompting action 418 taken; loss of fixed amount for any observation 410 or for specific categories of observations 410; loss of fixed amount for each machine-learned inference action; etc.). In some instances, a loss value associated with an operation (e.g., machine-learned inference operation, belief state generation operation, etc.) can be based on or otherwise correlated with a cost (e.g., computational cost such as electricity cost, memory usage, processor usage, etc.) of the operation. For example, in some instances, a computing system 108 may have access to a plurality of machine-learned models 114, belief state generators 104, or other computer-accessible tools (e.g., computer-implemented tools, etc.). In some instances, a first machine-learned model 114 or belief state generator 104 may be associated with a lower computational cost than a second machine-learned model 114 or belief state generator 104. In such instances, an objective function may include a first loss value for each operation of the first machine-learned model 114 or belief state generator 104 and a second loss value, which may be higher than the first loss value, for each operation of the second machine-learned model 114 or belief state generator 104.

In some instances, a Markov decision process 422 can select between actions based at least in part on an objective function comprising a loss value associated with a cost associated with the actions. For example, in some instances, a Markov decision process 422 can select a machine-learned model 114 or belief state generator 104 to use for an action 412, 418 or operation (e.g., belief state generation operation, etc.) based at least in part on a cost associated with the machine-learned model 114 or belief state generator 104. In some instances, a Markov decision process can select between actions 412, 418 that use or do not use a machine-learned model 114 or belief state generator 104 based at least in part on a cost associated with the machine-learned model 114 or belief state generator 104. For example, in some instances, a Markov decision process 422 may generate one or more first beliefs (e.g., entities, relationships, attributes, etc.) of a belief state 106, 112, 424, with each belief having an associated confidence value (e.g., probability-based confidence value, etc.). In some instances, a Markov decision process 422 may select whether to continue generating additional beliefs of the belief state 106, 112, 424 (e.g., based in part on the first belief states, etc.) or to stop generating additional beliefs and perform one or more other actions 412, 418. In some instances, such a selection can be made based on an objective function of the Markov decision process 422, such as based on a comparison between an estimated reward associated with generating additional beliefs and an estimated reward associated with performing another action. As another example, a Markov decision process 422 may select between a first action (e.g., machine-learned inference action 412, etc.) using a first component (e.g., machine-learned model 114, belief state generator 104) and a second action using a second component based on a comparison between estimated rewards associated with the first and second actions. As another example, a Markov decision process 422 may select whether or not to perform one or more machine-learned inference operations (e.g., machine-learned inference actions 412, etc.) based on a comparison between an estimated reward associated with a first action comprising the one or more machine-learned inference operations and a second action comprising fewer (e.g., zero, etc.) machine-learned inference operations. For example, in some instances, a number of machine-generated preview outputs (e.g., images, etc.) to provide as part of an update prompting action 418 can be selected based on a comparison between a reward associated with providing the preview outputs and a loss (e.g., cost, etc.) associated with generating the preview outputs.

In some instances, an objective value can include a cumulative sum of a plurality of reward or loss values, such as a plurality of values associated with a plurality of time steps associated with a plurality of states, actions, observations, or the like. For example, in some instances, at each time step where one or more outputs 116 may be provided to a user 220, a reward or loss associated with the outputs 116 (e.g., based on a similarity metric associated with the outputs 116, etc.) can be added to a cumulative total reward value. As another example, at each time step where one or more actions 412, 418 are performed, a loss value or cost value of the operations may be added to or subtracted from the cumulative reward value. Other reward functions are possible. For example, in some instances, a reward function can include a reward function determined based solely on a final timestep (e.g., similarity metric associated with an output 116 at a final timestep, etc.) given one or more constraints (e.g., maximum number of update prompting actions 418, maximum computational cost budget, etc.). Other implementations are possible.

In some instances, a reward function can include a reward value associated with an information gain at one or more time steps. For example, in some instances, a reward function can include a reward value based on a difference between a first entropy of a first belief state 106 at a first time step and a second entropy of a second belief state 112 at a second time step later than the first time step. For example, in some instances, an entropy associated with one or more entities, relationships, or attributes can include a sum such as

$$- {\sum }_{𝓍 ∈ 𝒳} p ( x ) log p ( x ) ,$$

where x is a particular value of an entity, attribute, or relationship; [symbol] is the set of all possible values of the entity, attribute, or relationship; and p(x) is a probability assigned to that value according to a belief state 106, 112, 424. In some instances, a reward function can include one or more weighted entropy values, such as one or more entropy values weighted by entity importance, attribute importance, relationship importance, or other weight values. For example, in some instances, a weighted entropy associated with an entity can include

$$- {imp}_{e} {\sum }_{𝓍 ∈ 𝒳} p ( x ) log p ( x ) ,$$

where impₑ is an importance value associated with the entity. As another example, in some instances, a weighted entropy associated with an attribute of an entity can include

$$- {imp}_{e} * {imp}_{a} {\sum }_{𝓍 ∈ 𝒳} p ( x ) log p ( x ) ,$$

where impₑ is an importance value associated with the entity and impₐ is an importance value associated with the attribute. As another example, in some instances, a weighted entropy value associated with a relationship between two or more entities can include:

$$- {imp}_{r} {\sum }_{𝓍 ∈ 𝒳} p ( x ) log p ( x ) , or$$

$$- {imp}_{r} {\prod }_{i = 1}^{n} {imp}_{ei} {\sum }_{𝓍 ∈ 𝒳} p ( x ) log p ( x ) ,$$

where impᵣ is an importance value associated with the relationship, and impₑᵢ is an importance value associated with one of n entities associated with the relationship.

In some instances, a function used to select one or more actions 412, 418 can include an estimation function configured to estimate a ground truth reward function. For example, in some instances, one or more actions can be selected based at least in part on a greedy information gain heuristic configured to estimate a ground truth information gain reward. In some instances, a greedy information gain heuristic can include selecting a prompting action 418 expected to minimize a weighted entropy of an updated belief state 112, 424 determined based on a belief state update 110 responsive to a prompting action 418. In some instances, selecting a prompting action to minimize an expected weighted entropy can include providing (e.g., to a user) a clarification question about a belief (e.g., entity, attribute, relationship, etc.) having a maximum total weighted entropy (e.g., according to one or more weighted entropy equations described above) among all such beliefs. Other implementations are possible (e.g., other heuristics, lookahead strategies, machine-learned reward estimation using a machine-learned model trained on action-reward pairs, etc.).

In some instances, an expected reward associated with an action 412, 418 can be based at least in part on one or more conditional probabilities. For example, in some instances, an expected reward associated with an action 412, 418 can be a weighted sum over a plurality of possible outcomes (e.g., observation 410 outcomes, reward value outcomes, etc.) of a plurality of expected rewards associated with the plurality of outcomes. For example, in some instances, an expected reward associated with an action 412, 418 can include:

$${\sum }_{y ∈ 𝒴} p ( y ) r ( y ) ,$$

Where [symbol] is the set of possible outcomes (e.g., observation 410 outcomes, etc.), p(y) is a probability of a particular outcome y, and r(y) is an expected reward associated with the outcome y.

A machine-learned inference action 412 can include an action associated with a Markov decision process (e.g., partially observable Markov decision process, modified partially observable Markov decision process, etc.), such as a Markov decision process 422 having one or more states, observations, actions, transitions, and rewards. In some instances, a machine-learned inference action 412 can include providing one or more second belief states 112 or inputs (e.g., text inputs, natural language prompts, etc.) based on the second belief states 112 to a machine-learned model 114 to generate outputs 116. In some instances, a Markov decision process can select between two or more machine-learned inference actions 412 based at least in part of a cost or loss value associated with the machine-learned inference actions 412. For example, in some instances, a number of outputs 116 to generate may be determined based at least in part on a cost or loss value associated with generating an output 116, along with one or more expected reward values (e.g., expected similarity metrics, expected user satisfaction scores, etc.) associated with generating a particular number of outputs. For example, a Markov decision process 422 can estimate, for each of a plurality of output 116 counts, a marginal benefit (e.g., difference between reward values such as maximum similarity metric, user satisfaction, etc.) of providing an additional output 116 (e.g., as part of a final output, preview output to provide in an update prompting action 418, etc.). In some instances, the Markov decision process 422 can select a number of outputs 116 to generate based on a comparison between the marginal benefits and a cost or loss value associated with generating an additional output 116.

In some instances, an update prompting action 418 can be, comprise, be comprised by, or otherwise share one or more properties with a belief state update prompt 218 or belief state update interface 218. For example, in some instances, a prompt update action 418 can have any property described above with respect to a belief state update prompt 218 or belief state update interface 218, or vice versa. In some instances, an update prompting action can include an action associated with a Markov decision process (e.g., partially observable Markov decision process, modified partially observable Markov decision process, etc.), such as a Markov decision process 422 having one or more states, observations, actions, transitions, and rewards.

In some instances, a Markov decision process 422 can select between a plurality of possible update prompting actions 418 (e.g., belief update prompts 218, belief update interfaces 318, etc.) based on a plurality of expected reward values respectively associated with the plurality of possible prompting actions 418. For example, any element depicted or described below with respect to FIGS. 6 and 7 can be included or not included in a belief state update interface 218 based at least in part on one or more estimated reward values. For example, an interface element (e.g., GUI element, clarification question, etc.) can be included in a belief state update interface 218 if an expected reward associated with an update prompting action 418 including the interface element is greater than an expected reward associated with an update prompting action 418 not including the interface element. In some instances, an ordering or other configuration (e.g., minimization, maximization, layout, etc.) of one or more interface elements (e.g., clarification questions, etc.) can be determined based at least in part on one or more estimated reward values.

In some instances, an expected reward value of an update prompting action 418 can be based on one or more of: a number of interface elements included in an interface associated with the update prompting action 418; an entropy of one or more beliefs (e.g., entities, attributes, relationships) included in or otherwise associated with the update prompting action; an estimated likelihood of receiving, responsive to the update prompting action, an observation 410 associated with a high-importance or high-entropy data item (e.g., entity, attribute, relationship) of a current belief state 424; or other value. As a non-limiting illustrative example, if only one entity of a current belief state 424 has a high weighted entropy (e.g., much higher than a second-highest weighted entropy, etc.), then a Markov decision process 422 may select an update prompting action 418 that asks a clarification question about the one entity. As another example, if a plurality of entities, attributes, or relationships of a current belief state 424 have similar weighted entropy values, then a Markov decision process 422 may select an update prompting action 418 that includes each of the plurality of entities, attributes, and relationships in a single belief state update interface 318 and allows a user to select which item(s) to update.

In some instances, a set of entities, attributes, or relationships to include in an update prompting action 418 can be selected based at least in part on an estimated marginal benefit of adding an additional entity, attribute, or relationship to the set. In some instances, an estimated marginal benefit can be based at least in part on a difference in weighted entropy between the additional item and one or more of: a maximum weighted entropy of the set, a mean or median weighted entropy of the set, a fixed entropy threshold, or other value. In some instances, a heuristic for selecting an update prompting action 418 can include selecting the N entities, attributes or relationships with the highest weighted entropy, highest importance, or other metric, wherein N can be a positive integer.

A Markov decision process 422 can be, for example, a partially observable Markov decision process or modified partially observable Markov decision process. In some instances, the Markov decision process 422 can be a decision process having a plurality of states; a plurality of possible transitions between the states; and one or more reward values associated with one or more states of the plurality of states. In some instances, each transition may be caused by or otherwise associated with a corresponding action 412, 418 or observation 410.

A current belief state 424 can be, comprise, be comprised by, or otherwise share one or more properties with a first belief state 406 or second belief state 112. For example, in some instances, a current belief state 424 can have any property described above with respect to a first belief state 406 or second belief state 112, or vice versa. In some instances, a transition between current belief states 424 can be the same as or different from a transition between a first belief state 106 and second belief state 112 based on a belief state update 110.

FIG. 5 is a block diagram of an example Markov decision process 522 according to some aspects of the present disclosure. At each of a plurality of iterations, a Markov decision process 522 can transition from a first state 524, 526 to a second state 524, 526 based on one or more observations 502, 410 performed by a computing system 108 or actions 418, 412, 528 selected by a computing system 108 according to the Markov decision process 522. At each belief state 524a, b, c, the Markov decision process 522 can select an action 418, 412 to perform. At each interface state 526a, b, c, the Markov decision process 522 can provide an interface (e.g., GUI view) to a user 220 and await an interface interaction (e.g., first input 102, belief update 110) associated with the interface.

An input observation 502 can include, for example, an observation of a Markov decision process (e.g., partially observable Markov decision process, modified partially observable Markov decision process, etc.) wherein a computing system 108 receives an input 102 (e.g., from a user). Responsive to receiving an input 102, a Markov decision process 522 can transition from a first interface state 526a (e.g., initial state associated with waiting for an initial input, etc.) to a first belief state 524a (e.g., based on a belief state 106, 112, 424 determined by a belief state generator 104, etc.).

A Markov decision process 522 can be, comprise, be comprised by, or otherwise share one or more properties with a Markov decision process 422. For example, in some instances, a Markov decision process 522 can have any property described above with respect to a Markov decision process 422 and vice versa. For example, a Markov decision process 522 can include selecting, at each of a plurality of iterations (e.g., at each of a plurality of belief states 524a, 524b, 524c), an action 418, 412 based on an estimated reward associated with one or more actions (e.g., as described above with respect to FIG. 4).

A belief state 524a, b, c can be, comprise, be comprised by, or otherwise share one or more properties with a belief state 106, 112 or belief state 406, 424. For example, in some instances, a belief state 524a, b, c, d can have any property described above with respect to a belief state 106, 112 or belief state 406, 424, and vice versa. In some instances, a belief state 524a can include a first belief state 106, while subsequent belief states 524b, c can include second belief states 112. In some instances, a belief state 524a can be a current belief state 424 associated with a first time; a belief state 524b can be a current belief state 424 associated with a second time later than the first time; and a belief state 524c can be a current belief state 424 associated with a third time later than the second time.

An interface state 526 can include, for example, a state in which a computing system 108 or Markov decision process 522 is awaiting an observation 502, 410. In some instances, an observation can include an interface interaction. In some instances, an observation can include a response (e.g., via a GUI, API, etc.) to a prompting action 418. In some instances, an observation (e.g., input/output operation, interface operation, etc.) can include an operation wherein a computing system 108 receives (e.g., from a user 220) data (e.g. belief state update 110 data) associated with a state transition (e.g., between belief states 106, 112, 424, 524; from an interface state 526 to a belief state 524, etc.).

An output action 528 can include, for example, an action to provide (e.g., to a user 220, etc.) an output 116 or other output of a machine-learned inference action 412 (e.g., without performing a prompting action 418. For example, in some instances, an output action 528 can include providing a final output via an interface (e.g., GUI, etc.) that does not include a mechanism for providing a belief state update 110. However, this is not required. For example, in some instances, one or more intermediate machine-learned inference actions 412a can be performed (e.g., to generate an output preview, candidate output, or the like) at an intermediate belief state 524b, and an output of the machine-learned inference actions 412a can be output (e.g., to a user 220 via a GUI, etc.) by a computing system 108 or Markov decision process 522 as part of a prompting action 418.

FIG. 6 is an illustration of an example graphical user interface (GUI) view 600 for collaboratively updating a belief state associated with a machine-learned image processing operation according to some aspects of the present disclosure. Responsive to receiving an input 102 or belief state update 110, a computing system 108 can provide the example GUI view to a user 220. The GUI view can include one or more of an input display 630, a clarification question display 632, a graph-structured belief state display 634, an output preview display 636, or other GUI components (e.g., settings tab 638, history tab 640, etc.). An input display 630 can include, for example, a display region showing an input 102 associated with a current belief state 424, and one or more input components 642 enabling a user 220 to edit the input 102 or provide a new input 102. A clarification question display 632 can include, for example, one or more clarification questions 644; one or more navigation components 646 to navigate between clarification questions; or other components. A graph-structured belief state display 634 can display one or more aspects of a current belief state 424, such as entities 647 or relationships 648 associated with a target output; attributes 650 of one or more entities 647 or relationships 648; or other belief state data. In some instances, the belief graph display can include one or more popup components 654 that can be hidden or surfaced responsive to a user 220 interaction (e.g., interaction with a detail display button 651, etc.), Markov decision process 422 action, or other event. In some instances, one or more aspects of the example GUI view (e.g., components to include or omit, ordering or content of the clarification question display 632, components to minimize or maximize, GUI layout, etc.) can be determined according to a Markov decision process 422.

An input display 630 can include, for example, a GUI component (e.g., tab, frame, pane, window, etc.) for displaying a current value of an input 102. In some instances, the input display 630 can include one or more other elements, such as a history function for viewing past inputs 102 using one or more navigation components 646; an input component 642 (e.g., edit button, text box, etc.) for editing the first input 102 or providing a new input 102; or other components. Further details of some example components that can be included in an input display 630 are further provided below with respect to FIG. 7.

In some instances, one or more aspects of an input display 630 can be selected according to a Markov decision process 422 (e.g., as described above with respect to FIG. 4 or FIG. 5). For example, a Markov decision process 422 can determine whether to include or not include an input display 630 in a GUI view 600; whether to include or not include one or more input components 642 in the input display 630; whether to include or not include various display data in the input display 630 (e.g., previous inputs 102, entity extraction displays or other displays, such as displays depicted below with respect to FIG. 7, etc.); or other aspects of the input display 630.

A clarification question display 632 can include, for example, a GUI component (e.g., tab, frame, pane, etc.) for displaying one or more clarification questions 644. In some instances, a clarification question display 632 can include one or more input components 642 (e.g., text box input components 642, multiple choice input components 642, etc.) for answering one or clarification questions 644. In some instances, the clarification question display 632 can include a plurality of clarification questions 644, and may include one or more navigation components 646 for navigating between questions.

In some instances, one or more aspects of a clarification question display 632 can be selected according to a Markov decision process 422 (e.g., as described above with respect to FIG. 4 or FIG. 5). For example, a Markov decision process 422 can determine whether to include or not include a clarification question display in a GUI view 600; whether to include or not include one or more input components 642 or navigation components 646 in the clarification question display 632; whether to include or not include various display data in the clarification question display 632 (e.g., importance data, confidence data, entity, attribute, or relationship data, etc.); or other aspects of the clarification question display 632. For example, in some instances, a clarification question display 632 can include questions about the N highest-entropy or highest-weighted-entropy aspects (e.g., entities, attributes, relationships, etc.) of a current belief state 424, where N is a positive integer. As another example, a clarification question display 632 can include questions about any aspects of a current belief state 424 associated with an entropy or weighted entropy greater than a threshold value (e.g., predetermined threshold, etc.). As another example, in some instances, a plurality of clarification questions can be ordered according to entropy or weighted entropy (e.g., highest first, etc.). In some instances, a plurality of clarification questions can be ordered based in part on an entropy or weighted entropy, and based in part on a hierarchical decomposition of related properties, wherein a second or later question depends in part on an answer associated with a first or earlier question.

A graph-structured belief state display 634 can include, for example, a GUI view (e.g., tab, frame, pane, etc.) for displaying belief state data associated with a belief state 106, 112, 424 (e.g., a current belief state 424). In some instances, the belief state data can include graph-structured data. In some instances, graph-structured data can be displayed in a graph format or another format (e.g., list view, table view, etc.). Although FIG. 6 depicts one graph-structured belief state display 634, other numbers are possible (e.g., zero, two, etc.). For example, in some instances, a current belief state 424 can include a probability distribution over two or more belief states 106, 112, 424, and a GUI view 600 can include separate graph-structured displays 634 for two or more belief state 106, 112, 424 values. Other implementations are possible.

In some instances, a graph-structured belief state display 634 can include a plurality of layers, such as an entity layer, an attribute layer, a relationship layer, or other layer type. In some instances, a graph-structured belief state display 634 or GUI view 600 can include an input component 642 to enable a user to hide or surface one or more of the layers according to a user preference. In some instances, a Markov decision process 422 can determine which layer(s) of a plurality of layers to display to a user in an initial state of a graph-structured belief state display 634 (e.g., with or without an input component 642 enabling the user to modify the initial state).

In some instances, one or more aspects of a graph-structured belief display 634 can be selected according to a Markov decision process 422 (e.g., as described above with respect to FIG. 4 or FIG. 5). For example, a Markov decision process 422 can determine whether to include or not include a graph-structured belief state display in a GUI view 600; whether to include or not include one or more input components 642 or navigation components 646 in the graph-structured belief state display 634; whether to include or not include various display data in the graph-structured belief state display 634 (e.g., importance data, confidence data, attribute data, etc.); whether to surface (e.g., maximize) or hide (e.g., minimize) various display data associated with the graph-structured belief state display 634; or other aspects of the graph-structured belief state display 634.

An output preview display 636 can include, for example, a GUI view (e.g., tab, frame, pane, etc.) for displaying one or more outputs 116 or portions thereof. In some instances, an output preview can include a fully generated output 116 or another value, such as a partially generated output 116 (e.g., first paragraph of a language output 116, first few seconds of an audio or video output 116, image region or other subset of an image output 116, etc.). In some instances, an output preview display 636 can include one or more input components 642 for interacting with one or more output previews (e.g., zoom or scroll input component 642, play button input component 642 for playing an audio or video output 116, etc.). Although FIG. 6 depicts one output preview display 636 showing four output previews, other numbers are possible (e.g., zero output preview displays 636, one or two output preview images, etc.).

In some instances, an output preview display 636 can include or be paired with one or more output editing tools (e.g., image editing tools, etc.) for editing one or more outputs. Example image editing tools can include, for example, selection tools (e.g., cropping tools, outlining tool, “lasso” tools, etc.) to select a region of a preview image; prompting tools for prompting a machine-learned model to perform an edit (e.g., text box for machine-learned models configured to receive natural language input, etc.); manual editing tools to directly edit the output (e.g., editable text box for editing text outputs; image editing tools for editing image outputs such as paintbrush tools, brightness, saturation, and contrast tools, copying and pasting tools, etc.); or other editing tools. In some instances, a subset of a plurality of possible editing tools can be selected by a Markov decision process 422 (e.g., based on an estimated reward function or cost function associated with each editing tool) to avoid overwhelming a user 220 with too many editing options.

In some instances, one or more aspects of an output preview display 636 can be selected according to a Markov decision process 422 (e.g., as described above with respect to FIG. 4 or FIG. 5). For example, a Markov decision process 422 can determine whether to include or not include an output preview display 636 in a GUI view 600; whether to include or not include one or more input components 642 or navigation components 646 in the output preview display 636; a number or type of output preview(s) to include in the output preview display 636; or other aspects of the output preview display 636.

A settings tab 638 can include, for example, a GUI component (e.g., tab, frame, pane, etc.) configured to display one or more settings (e.g., GUI settings such as display settings or input settings; inference settings; output settings; etc.) and provide one or more user interface components for a user 220 to modify the one or more settings.

A history tab 640 can include, for example, a GUI component (e.g., tab, frame, pane, etc.) configured to display one or more past inputs 102, past belief states 106, 112, past belief state updates 110, past outputs 116, or other history data associated with a GUI view 600 or belief state 106, 112.

Input components 642 can include, for example, any GUI components configured to receive an input (e.g., from a user 220), such as buttons, text boxes, check boxes, radio buttons, drop-down lists, hyperlinks, or other input components. Input components 642 can be configured to perform a variety of actions, such as regenerate buttons configured to request generation of one or more new entity 647, attribute 650, or relationship 648 values; edit components configured to provide a belief state update 110 or surface another input component 642 for providing a belief state update 110; submit buttons configured to submit a belief state update 110 based on data input via another input component 642; selection components configured to select a belief value (e.g., entity 647, attribute 650, relationship 648, etc.) from a plurality of candidate belief values; or other input components.

A clarification question 644 can include, for example, any question about an input 102, belief state 106, 112, 424, output 116, or other topic. In some instances, a clarification question 644 can include a question about a single data item (e.g., entity 647, relationship 648, attribute 650) associated with a current belief state 424. In some instances, a clarification question 644 can include a question about more general information that may be associated with a plurality of data items 647, 648, 650. In some instances, one or more aspects of the clarification questions 644 or clarification question display 632 can be selected according to a Markov process 422 (e.g., as described above with respect to a clarification question display 632). For example, in some instances, a Markov decision process 422 can include selecting which clarification questions 644 to include in a GUI view 600. In some instances, a Markov decision process 422 can include selecting what ordering to display a plurality of questions in. In some instances, a Markov decision process 422 can include selecting whether to present a question as a multiple-choice question or as an open-ended question (e.g., with an open-ended text box input component 642, etc.). In some instances, a Markov decision process 422 can include selecting a manner of displaying the clarification questions 644, such as one at a time, multiple questions in a list view, or other manner of display.

A navigation component 646 can include, for example, an input component 642 configured for navigation between components or subcomponents of a GUI view 600, such as navigation between clarification questions 644 of a clarification question display 632; navigation between GUI components such as tabs, frames, windows, displays 630, 632, 634, 636; or other forms of GUI navigation.

An entity 647 can include, for example, an entity associated with a current belief state 424 being displayed in the graph-structured belief state display 634. In some instances, an entity 647 can include an entity to be included in or otherwise associated with an output 116. In some instances, an entity 647 can include an entity named, described, or otherwise referenced in an input 102. In some instances, an entity 647 can include an entity not referenced in an input 102, such as an entity inferred from the input 102 (e.g., by a belief state generator 104, etc.). In some instances, an entity 647 can include an entity determined (e.g., randomly sampled, etc.) based on a probability distribution associated with a current belief state 424.

A relationship 648 can include, for example, a relationship 648 between two or more entities 647 associated with a current belief state 424. In some instances, a relationship 648 can include a relationship named, described, or otherwise referenced in an input 102. In some instances, a relationship 648 can include a relationship not referenced in an input 102, such as a relationship inferred from the input 102 (e.g., by a belief state generator 104, etc.). In some instances, a relationship 648 can include a relationship determined (e.g., randomly sampled, etc.) based on a probability distribution associated with a current belief state 424.

In some instances, a relationship 648 can include a directed relationship (e.g., contains, is above, etc.) or undirected relationship (e.g., is paired with, is electrically coupled to, etc.). In some instances, a relationship 648 can be paired with one or more input components 642 for changing a direction of the relationship 648. As a non-limiting illustrative example, a GUI may include an arrow illustrating a direction of the relationship 648, and the arrow may function as an input component 642 for editing the direction (e.g., by dragging and dropping a “head” of the arrow, etc.). In some instances, a relationship 648 can be paired with one or more input components 642 for editing the relationship 648 in other ways, such as changing one or more entities associated with the relationship (e.g., via a drag-and-drop editing interface, such as a drag-and-drop arrow or line segment, etc.).

An attribute 650 can include, for example, an attribute of a relationship 648 or entity 647 associated with a current belief state 424. In some instances, an attribute 650 can include an attribute named, described, or otherwise referenced in an input 102. In some instances, an attribute can include an attribute not referenced in an input 102, such as an attribute inferred from the input 102 (e.g., by a belief state generator 104, etc.). In some instances, an attribute 650 can include a relationship determined (e.g., randomly sampled, etc.) based on a probability distribution associated with a current belief state 424.

A detail display button 651 can include, for example, an input component 642 configured to display additional detail about one or more data items (e.g., entities 647, attributes 640, relationships 648, etc.) associated with a belief state 106, 112. Other input components 642 are possible. Although FIG. 6 depicts a detail display button 651 for each entity 647 and relationship 648, other numbers of detail display buttons 651 or input components 642 are possible (e.g., one or more detail display buttons 651 for an attribute 640, one or more entities 647 or relationships 648 without detail display buttons 651, etc.)

In some instances, any aspect of a GUI view 600, 700 or component thereof (e.g., settings tab 638, history tab 640, input component 642, navigation component 646, entity 647 display, relationship 648 display, attribute 640 display, etc.) can be selected according to a Markov decision process 422 (e.g., as described above with respect to FIG. 4 or FIG. 5, as described above with respect to various individual components of a GUI view 600, etc.). For example, in some instances, a Markov decision process 422 can select a GUI view having one or more properties or components that are the same as or different from any property depicted herein with respect to a GUI view 600, 700.

Further details of some example GUI views 600, 700 of some example experiments according to some aspects of the present disclosure are provided in Section G of “Proactive Agents for Multi-Turn Text-to-Image Generation Under Uncertainty,” https://arxiv.org/pdf/2412.06771, which is incorporated by reference herein and forms a part of this disclosure.

FIG. 7 is an illustration of an example GUI view 700 for collaboratively updating a belief state according to some aspects of the present disclosure. Responsive to receiving a first input 102 or belief state update 110, a computing system 108 can provide the example GUI view 700 to a user 220. The GUI view 700 can include one or more of a first input display 730, a clarification question display 732, and a graph-structured belief state display 734. In some instances, the example GUI view 700 can lack any output preview 636, such as in instances when a Markov decision process 422 determines that a reward associated with providing the output preview 636 would be lower than a reward associated with providing a GUI view without the image preview 636 (e.g., due to high uncertainty associated with one or more beliefs; high computational cost of producing an output preview 636; high reputational cost or user satisfaction cost of showing an unsatisfactory output preview 636; etc.). In some instances, the first input display 730 can include one or more annotations 752 highlighting entities, attributes, relationships, or other data identified in the first input 102 according to the current belief state 424.

In some instances, one or more annotations 752 can include one or more popup components 754 (e.g., mouseover popups, clickable popups, etc.) displaying data regarding beliefs of the current belief state associated with the annotation 752 (e.g., attributes, importance levels, confidence levels, etc.) or providing the ability to change a belief value (e.g., by clicking on a dropdown menu and selecting an alternate option). In some instances, one or more entities 647 or relationships 648 of the graph-structured belief state display 734 can include one or more popup components 754 displaying beliefs associated with the entities 647 or relationships 648. In some instances, one or more annotations 752 or other GUI view 700 components can include one or more regenerate buttons 742 for generating (e.g., randomly sampling, etc.) a new value for one or more beliefs (e.g., entities 647, attributes 650, relationships 648, etc.).

A clarification question display 732 can be, comprise, be comprised by, or otherwise share one or more properties with a clarification question display 632. For example, a clarification question display 732 can have any property described above with respect to a clarification question display 632 and vice versa. In some instances, a clarification question display 732 can have one or more properties that are different from the clarification question display 632 depicted with respect to FIG. 6. In some instances, a clarification question display 732 can have one or more properties selected according to a Markov decision process 422, such as a number of clarification questions 644 to display; a display style (e.g., displaying multiple questions at once; displaying questions in a list view; etc.); one or more multiple-choice answer values; one or more input component 642 styles (e.g., text box, multiple choice clickable input component 642, etc.) to associate with the clarification questions 644; or other properties.

A graph-structured belief state display 734 can be, comprise, be comprised by, or otherwise share one or more properties with a graph-structured belief state display 634. For example, in some instances, a graph-structured belief state display 734 can have any property described above with respect to a graph-structured belief state display 634 or vice versa. In some instances, a graph-structured belief state display 734 can include one or more extracted beliefs 747a indicative of data that was identified as being expressly included in an input 102, and one or more inferred or assumed beliefs 747b that were not included in the input 102. For example, in some instances, an inferred or assumed belief 747b can include an entity 647, relationship 648, attribute 650, or probability distribution determined (e.g., generated, etc.) by a belief state generator 104 based at least in part on an input 102. In some instances, an inferred or assumed belief 747b can include an entity 647, relationship 648, attribute 650, determined by the belief state generator 104 to be a likely target output property given the contents of the input 102. As a non-limiting illustrative example, a belief state generator 104 may, responsive to receiving an input 102 requesting a circuit diagram of an “accelerator chip,” infer that an “accelerator chip” is likely to include a “high-bandwidth memory” entity or an interconnection entity (e.g., PCIe bus), regardless of whether such an entity is expressly included in an input 102 requesting the circuit diagram.

An output attribute 748 can include, for example, one or more target attributes associated with an output 116, such as a target style (e.g. image style, musical genre, cinematography style, document style, writing style, etc.) associated with the output 116. In some instances, an output attribute 748 can include a holistic attribute indicative of a property of an output 116 as a whole (e.g., rather than an individual component of the output 116 such as an individual entity 647).

In some instances, a regenerate button 742 can be, comprise, be comprised by, or otherwise share one or more properties with an input component 642. For example, in some instances, a regenerate button 742 can have any property described above with respect to an input component 642 and vice versa. In some instances, a regenerate button 742 can be an interface component 642 that, when interacted with (e.g., clicked, etc.) by a user, will cause a computing device 108 to generate a new value for one or more beliefs (e.g., entities 647, attributes 650, relationships 648, etc.) associated with the regenerate button 742. In some instances, generating a new value can include randomly sampling a new value from a probability distribution associated with the belief state 106. Other implementations are possible (e.g., using a belief state generator 104 to generate a new probability distribution, etc.).

An annotation 752 can include, for example, any display component showing data associated with the input 102, such as entities, attributes, relationships, output attributes 748, or other data identified in the input 102 according to a current belief state 424. In some instances, an annotation 752 can display entity extraction data, attribute extraction data, or relationship extraction data extracted from the input 102 by a belief state generator 104. In some instances, an annotation 752 can include other data, such as data inferred by a belief state generator 104, data received via a belief state update 110, or other data. In some instances, an annotation 752 can include color-coded display data, such as color-coded highlighting wherein entities 647 may be highlighted in a first color; attributes 650 may be highlighted in a second color; relationships 648 may be highlighted in a third color; and output attributes 748 may be highlighted in a fourth color. Other implementations are possible.

In some instances, the first input display 730 can include one or more annotations 752 highlighting entities, attributes, relationships, or other data identified in the first input 102 according to the current belief state 424.

A popup component 754 can be, for example, a display component that can be surfaced (e.g., maximized, popped up, etc.) or hidden (e.g., minimized, etc.) responsive to various user 220 actions, such as responsive to a clicking action (e.g., clicking of a detail display button 651, etc.), mouseover action, or other user 220 action. A popup component 754 can display, for example, various data associated with a belief state 106, 112 (e.g., attributes 650 of an entity 647 or relationship 648; confidence levels or importance levels associated with one or more attributes 640; input components 642, such as “+” or “−” buttons configured to increase or decrease a numerical value (e.g., confidence, importance, etc.) responsive to a user 220 interaction; or other display components.

### EXAMPLE METHODS

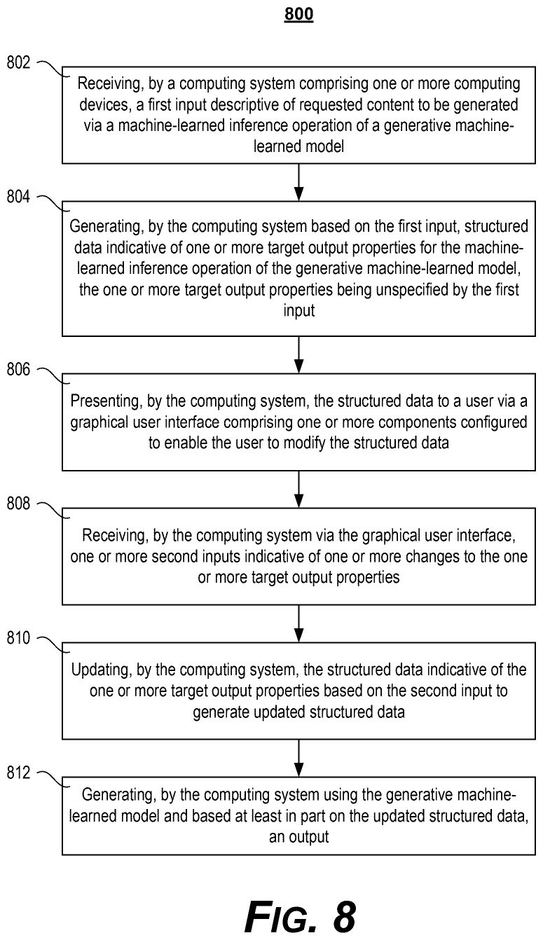

FIG. 8 depicts a flowchart diagram of an example method for machine-learned inference based on interactively updated beliefs according to example embodiments of the present disclosure. Although FIG. 8 depicts steps performed in a particular order for purposes of illustration and discussion, the methods of the present disclosure are not limited to the particularly illustrated order or arrangement. The various steps of example method 800 can be omitted, rearranged, combined, and/or adapted in various ways without deviating from the scope of the present disclosure.

At 802, example method 800 can include receiving, by a computing system comprising one or more computing devices, a first input (e.g., input 102 input observation 502, etc.) descriptive of requested content to be generated via a machine-learned inference operation of a generative machine-learned model (e.g., machine-learned model 114). In some instances, example method 800 at 802 can include using one or more systems or performing one or more activities described with respect to FIGS. 1-5.

At 804, example method 800 can include generating, by the computing system based on the first input, structured data (e.g., first belief state 106, etc.) indicative of one or more target output properties for the machine-learned inference operation of the generative machine-learned model, the one or more target output properties being unspecified by the first input. In some instances, example method 800 at 804 can include using one or more systems or performing one or more activities described with respect to FIGS. 1-5.

At 806, example method 800 can include presenting, by the computing system, the structured data to a user via a graphical user interface (e.g., graphical user interface 600, graphical user interface 700, etc.) comprising one or more components (e.g., input components 642, etc.) configured to enable the user to modify the structured data. In some instances, example method 800 at 806 can include using one or more systems or performing one or more activities described with respect to FIGS. 1-7.

At 808, example method 800 can include receiving, by the computing system via the graphical user interface, one or more second inputs (e.g., belief state updates 110) indicative of one or more changes to the one or more target output properties. In some instances, example method 800 at 808 can include using one or more systems or performing one or more activities described with respect to FIGS. 1-7.

At 810, example method 800 can include updating, by the computing system, the structured data indicative of the one or more target output properties based on the second input to generate updated structured data (e.g., second belief state 112). In some instances, example method 800 at 810 can include using one or more systems or performing one or more activities described with respect to FIGS. 1-5.

At 812, example method 800 can include generating, by the computing system using the generative machine-learned model and based at least in part on the updated structured data, an output (e.g., output 116). In some instances, example method 800 at 812 can include using one or more systems or performing one or more activities described with respect to FIGS. 1-5.

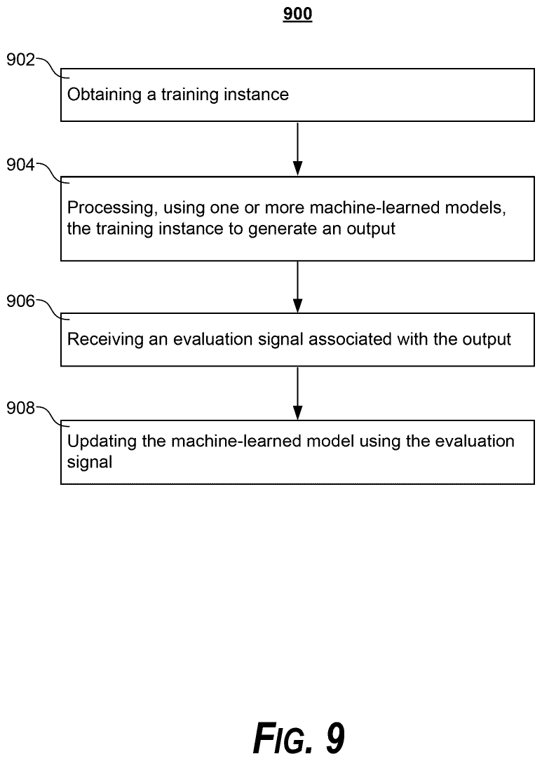

FIG. 9 depicts a flowchart of a method 900 for training one or more machine-learned models according to aspects of the present disclosure. For instance, an example machine-learned model can include a machine-learned model 114 or belief state generator 104.

One or more portion(s) of example method 900 can be implemented by a computing system that includes one or more computing devices such as, for example, computing systems described with reference to the other figures. Each respective portion of example method 900 can be performed by any (or any combination) of one or more computing devices. Moreover, one or more portion(s) of example method 900 can be implemented on the hardware components of the device(s) described herein, for example, to train one or more systems or models. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 9 is described with reference to elements/terms described with respect to other systems and figures for exemplary illustrated purposes and is not meant to be limiting. One or more portions of example method 900 can be performed additionally, or alternatively, by other systems.

At 902, example method 900 can include obtaining a training instance. A set of training data can include a plurality of training instances divided between multiple datasets (e.g., a training dataset, a validation dataset, or testing dataset). A training instance can be labeled or unlabeled. Although referred to in example method 900 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 904, example method 900 can include processing, using one or more machine-learned models, the training instance to generate an output. The output can be directly obtained from the one or more machine-learned models or can be a downstream result of a chain of processing operations that includes an output of the one or more machine-learned models.

At 906, example method 900 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 908, example method 900 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 900 can include implementing a number of generalization techniques (e.g., weight decays, dropouts, etc.) to improve the generalization capability of the models being trained.

In some implementations, example method 900 can be implemented for training a machine-learned model from an initialized state to a fully trained state (e.g., when the model exhibits a desired performance profile, such as based on accuracy, precision, recall, etc.).

In some implementations, example method 900 can be implemented for particular stages of a training procedure. For instance, in some implementations, example method 900 can be implemented for pre-training a machine-learned model. Pre-training can include, for instance, large-scale training over potentially noisy data to achieve a broad base of performance levels across a variety of tasks/data types. In some implementations, example method 900 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

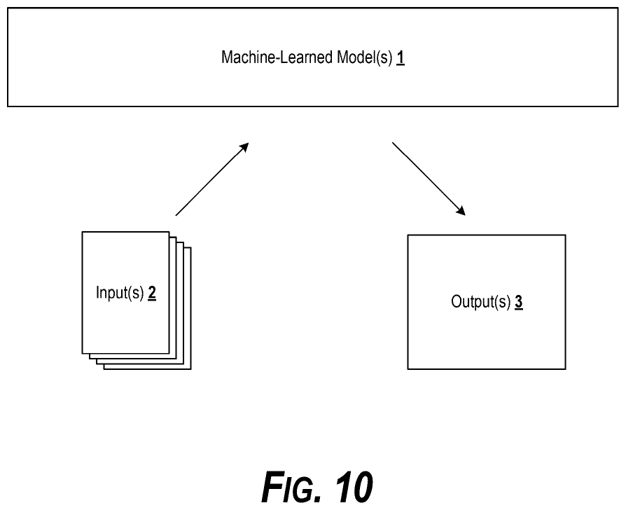

FIG. 10 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

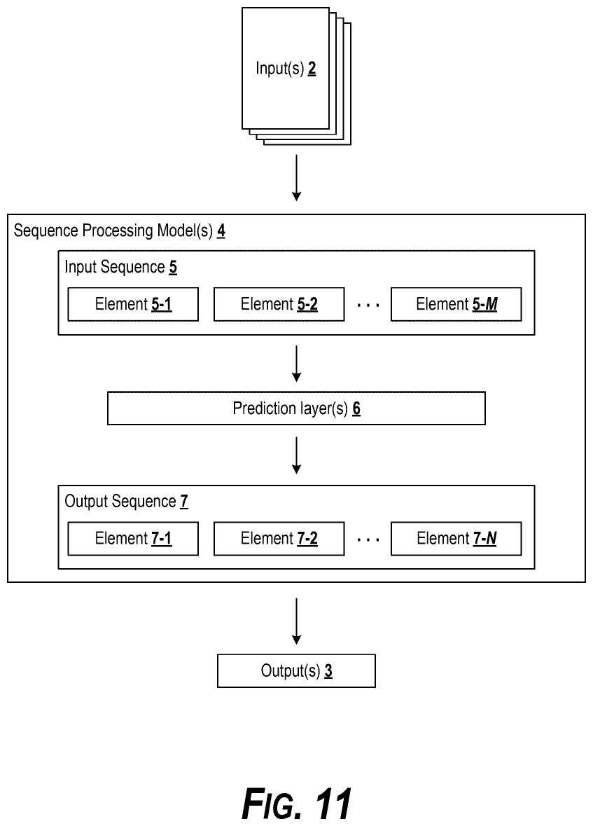

FIG. 11 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 11 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of _.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

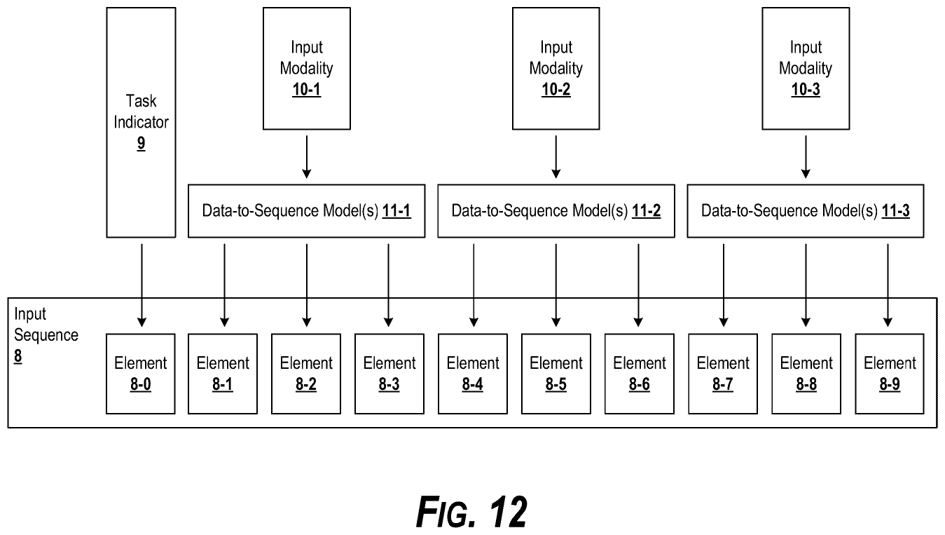

FIG. 12 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

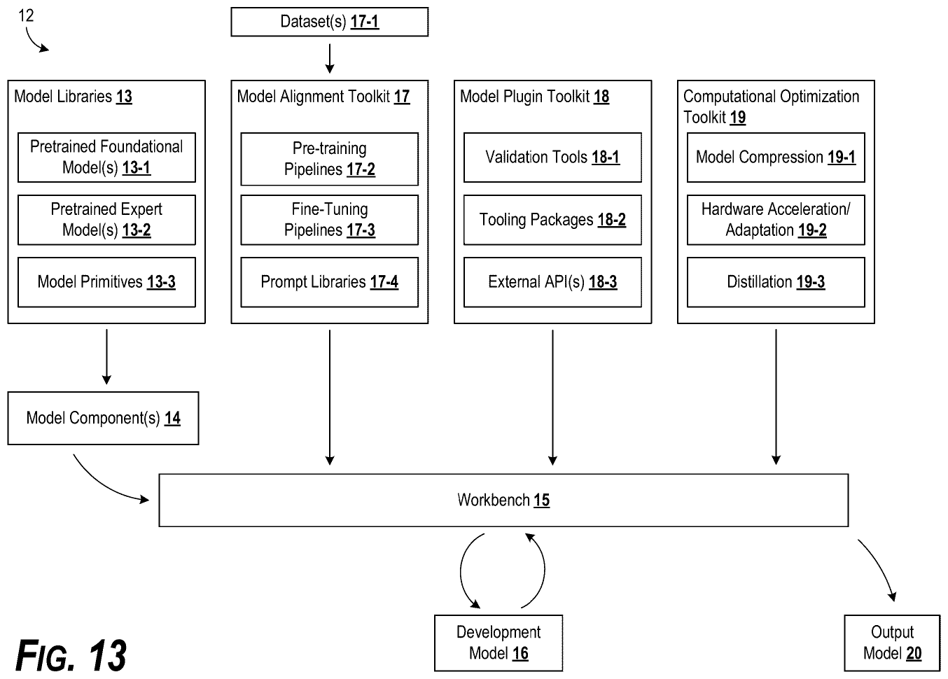

FIG. 13 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 900 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

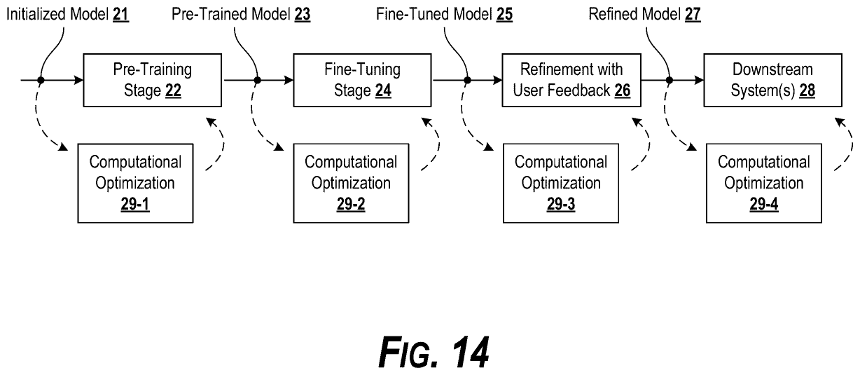

FIG. 14 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 14 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 14 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

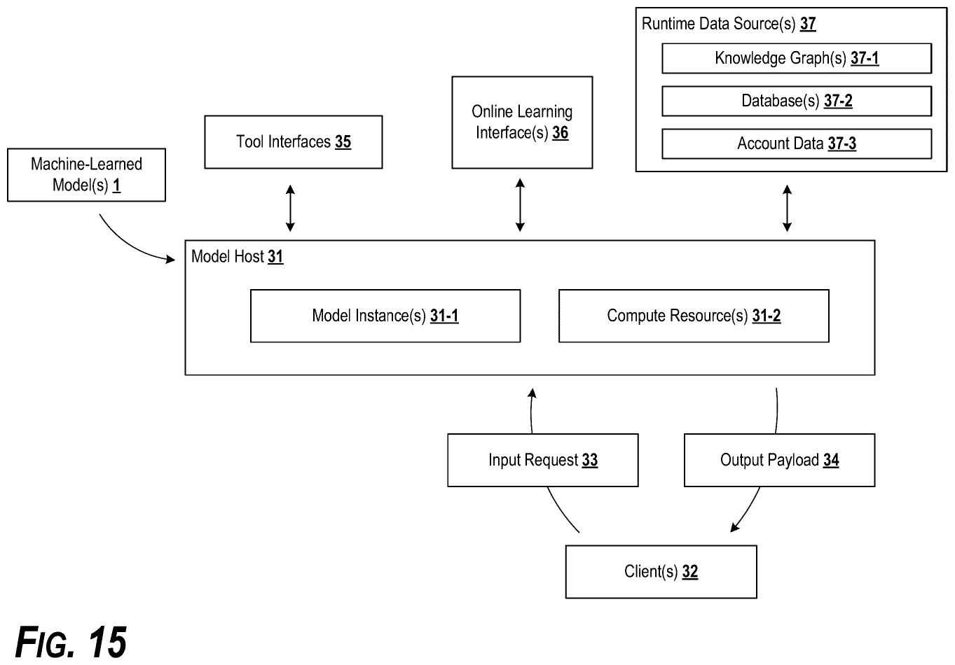

FIG. 15 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

FIG. 16 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 16 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 16 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

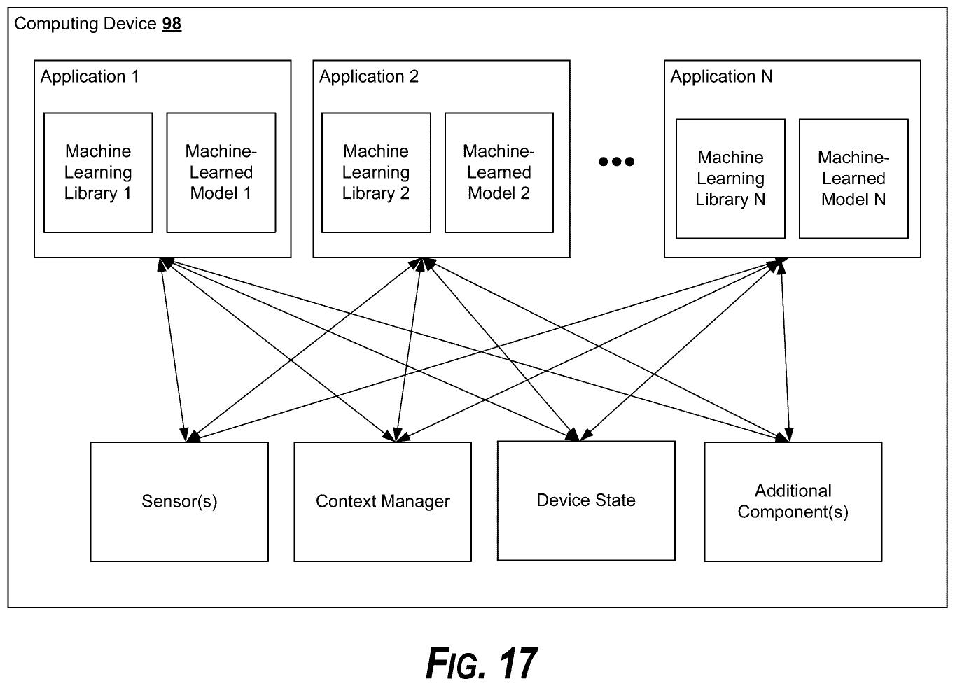

FIG. 17 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 17, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

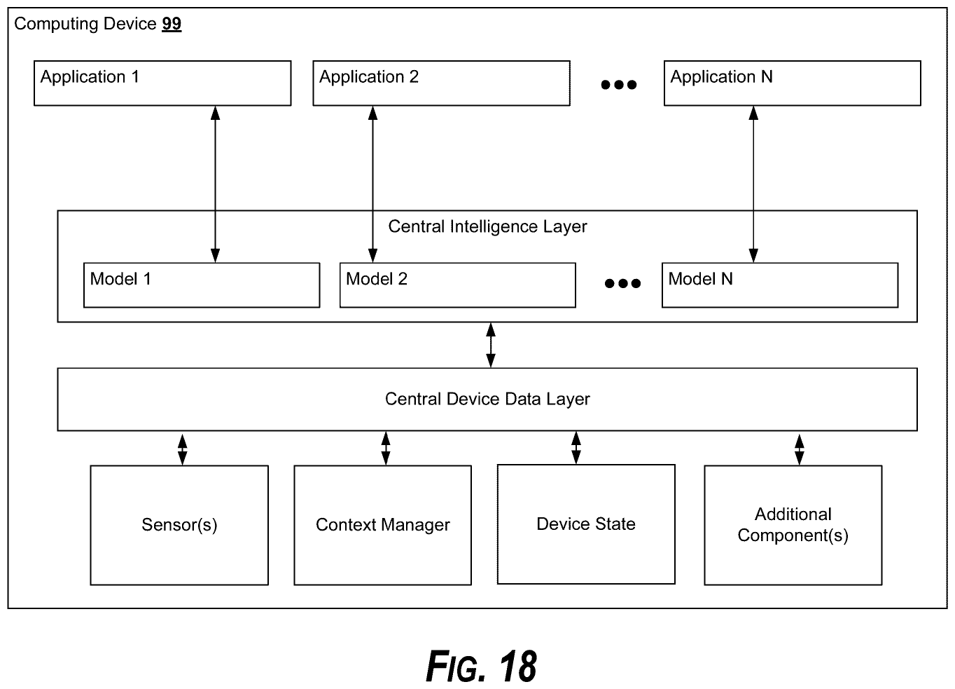

FIG. 18 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 18, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 18, the central device data layer can communicate with a number of other components of the computing device, such as, for example, one or more sensors, a context manager, a device state component, or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A method for machine-learned inference using an interactively updated belief state, comprising:
receiving, by a computing system comprising one or more computing devices, a first input descriptive of requested content to be generated via a machine-learned inference operation of a generative machine-learned model;
generating, by the computing system based on the first input, structured data indicative of one or more target output properties for the machine-learned inference operation of the generative machine-learned model, the one or more target output properties being unspecified by the first input;
presenting, by the computing system, the structured data to a user via a graphical user interface comprising one or more components configured to enable the user to modify the structured data;
receiving, by the computing system via the graphical user interface, one or more second inputs indicative of one or more changes to the one or more target output properties;
updating, by the computing system, the structured data indicative of the one or more target output properties based on the second input to generate updated structured data; and
generating, by the computing system using the generative machine-learned model and based at least in part on the updated structured data, an output.

2. The method of claim 1, wherein the structured data comprises a probability distribution over a plurality of sets of target output properties.

3. The method of claim 2, wherein at least one second input of the one or more second inputs is indicative of a value for a first target output property of the one or more target output properties, and updating the one or more target output properties comprises:
updating, by the computing system, the first target output property according to the value; and
updating, by the computing system based at least in part on the value, one or more probabilities associated with a second target output property of the one or more target output properties.

4. The method of claim 3, wherein the generative machine-learned model is a first machine-learned model, and updating the one or more probabilities comprises:
providing, by the computing system to a second machine-learned model, a third input comprising data indicative of:
the value; and
all or part of the first input; and
generating, by the computing system using the second machine-learned model, one or more updated probabilities associated with the second target output property.

5. The method of claim 2, further comprising:
generating, by the computing system based at least in part on one or more probabilities associated with the probability distribution, a graphical user interface (GUI) view; and
providing, by the computing system via the graphical user interface, the GUI view to a user.

6. The method of claim 5, wherein the one or more probabilities comprise one or more confidence levels, and generating the GUI view based at least in part on the one or more probabilities comprises:
determining, by the computing system based on the one or more confidence levels, one or more entropy values associated with the one or more target output properties;
selecting, by the computing system based at least in part on the one or more entropy values, according to a Markov decision process, a GUI view generation action; and
performing, by the computing system, the GUI view generation action.

7. The method of claim 1, wherein the updated structured data comprises a probability distribution over a plurality of sets of target output properties, and generating the output comprises:
sampling, by the computing system based on the probability distribution, a value for a first target output property; and
providing, by the computing system to the generative machine-learned model, input context indicative of the value for the first target output property.

8. The method of claim 1, wherein the structured data comprises graph-structured data comprising two or more entities to be included in a target output of the machine-learned inference operation and one or more relationships between the two or more entities.

9. The method of claim 8, wherein the structured data further comprises one or more attributes associated with at least one entity of the two or more entities.

10. The method of claim 8, wherein the structured data further comprises an importance associated with at least one of:
at least one entity of the two or more entities;
at least one relationship of the one or more relationships; and
at least one attribute associated with at least one entity of the two or more entities.

11. The method of claim 1, wherein the graphical user interface comprises a graph-structured view of two or more entities to be included in an output of the machine-learned inference operation and one or more relationships between the two or more entities.

12. The method of claim 1, wherein the graphical user interface comprises a user prompt a prompt to define a value for a first target output property of the one or more target output properties, and wherein receiving the second input comprises receiving, by the computing system via the graphical user interface, an input associated with the prompt.

13. The method of claim 12, further comprising generating the user prompt by:
providing, by the computing system to a second machine-learned model, a third input comprising all or part of the first input; and
generating, by the computing system using the second machine-learned model based on the third input, the user prompt.

14. The method of claim 1, wherein the generative machine-learned model is a first machine-learned model, and generating the structured data comprises:
providing, by the computing system to a second machine-learned model, a third input comprising all or part of the first input; and
generating, by the computing system using the second machine-learned model, the structured data.

15. The method of claim 14, wherein the third input comprises a plurality of example input-output pairs, each example input-output pair comprising an example input associated with an example machine-learned inference operation and an example output comprising example structured data indicative of one or more example target output properties for the example machine-learned inference operation.

16. The method of claim 15, wherein the one or more example target output properties comprise:
two or more example entities to be included in the example machine-learned inference operation; and
one or more example relationships between the two or more example entities.

17. The method of claim 14, wherein the second machine-learned model comprises a language model.

18. The method of claim 1, wherein the generative machine-learned model comprises an image processing model.

19. One or more non-transitory computer-readable media storing instructions that are executable by one or more processors to cause a computing system to perform operations, the operations comprising:
receiving a first input descriptive of requested content to be generated via a machine-learned inference operation of a generative machine-learned model;
generating, based on the first input, structured data indicative of one or more target output properties for the machine-learned inference operation of the generative machine-learned model, the one or more target output properties being unspecified by the first input;
presenting the structured data to a user via a graphical user interface comprising one or more components configured to enable the user to modify the structured data;
receiving, via the graphical user interface, one or more second inputs indicative of one or more changes to the one or more target output properties;
updating the structured data indicative of the one or more target output properties based on the second input to generate updated structured data; and
generating, using the generative machine-learned model and based at least in part on the updated structured data, an output.

20. A computing system comprising one or more processors and one or more non-transitory computer-readable media storing instructions that are executable by one or more processors to cause the computing system to perform operations, the operations comprising:
receiving a first input descriptive of requested content to be generated via a machine-learned inference operation of a generative machine-learned model;
identifying, based at least in part on the first input, one or more output properties that are unspecified by the first input;
presenting, to a user based on the one or more output properties, a graphical user interface to specify the one or more output properties;
receiving, via the graphical user interface, one or more second inputs indicative of one or more values for the one or more output properties;
providing, to the generative machine-learned model based at least in part on the first input and the one or more values for the one or more output properties, a third input descriptive of the requested content and descriptive of the one or more values for the one or more output properties; and
generating, using the generative machine-learned model and based at least in part on the third input, an output.

21. The computing system of claim 20, wherein the graphical user interface comprises one or more clarification questions associated with the one or more output properties that are unspecified by the first input, and wherein the graphical user interface comprises a question-answering input component for answering the one or more clarification questions.
